(19) United States
(12) Patent Application Publication
(10) Pub. No.: US 2022/0388856 A1
(43) Pub. Date: Dec. 8, 2022

(54) COLD SINTERING PROCESS OF USING SODIUM BETA ALUMINA

(71) Applicant: The Penn State Research Foundation, University Park, PA (US)

(72) Inventors: Zane Michael Grady, University Park, PA (US); Arnaud Ndayishimiye, University Park, PA (US); Clive A. Randall, University Park, PA (US)

(21) Appl. No.: 17/656,587

(22) Filed: Mar. 25, 2022

Related U.S. Application Data
(60) Provisional application No. 63/192,809, filed on May 25, 2021.

(51) Int. Cl. C01F 7/028; H01M 4/04; H01M 10/0562

(52) U.S. Cl. CPC C01F 7/028; H01M 4/0407; H01M 10/0562; H01M 2300/0071; C01P 2006/10

(57) ABSTRACT

Embodiments relate to a method for fabricating a sintered sodium-ion material. The method involves mixing a parent phase sodium-ion compound with a secondary transient phase to form a powder mixture. The method involves applying pressure and heat above a melting point or boiling point of the secondary transient phase to drive dissolution at particle contacts and subsequent precipitation at newly formed grain boundaries. The method involves generating a sintered sodium-ion material with >90% relative density.

### CROSS-REFERENCE TO RELATED APPLICATIONS

This application claims priority to U.S. Provisional Patent Application No. 63/192,809, which was filed on May 25, 2021. The entirety of this application is incorporated by reference herein.

### STATEMENT REGARDING FEDERALLY SPONSORED RESEARCH DEVELOPMENT

This invention was made with government support under Grant No. DE-AC05-76RL01830 awarded by the Department of Energy and under Grant No. FA9550-19-1-0372 awarded by the United States Air Force/AFOSR. The Government has certain rights in the invention.

### FIELD OF THE INVENTION

Embodiments relates to methods for generating a sintered sodium beta alumina solid electrolyte having a relative density>90% within a three hour dwell time.

### BACKGROUND OF THE INVENTION

Sodium beta alumina can be used as a commercialized solid electrolyte for high temperature batteries (e.g., operation temperatures>200° C.). The conventional sintering process has challenged researchers for 50 years; the high temperatures required for good densification result in abnormal grain growth, mechanically fragile polycrystalline ceramics, and significant sodium loss.

Known sintering methods can be appreciated from U.S. Pat. Nos. 3,795,723, 3,959,022, 4,052,538, 4,138,455, 4,167,550, 4,193,954, and CN 105637694.

### BRIEF SUMMARY OF THE INVENTION

Embodiments relate to a low temperature sintering process (cold sintering) applied to a sodium beta alumina solid electrolyte. With cold sintering parameters of 10 wt. % NaOH, 375° C., and 360 MPa of uniaxial pressure, a relative density of 93% was achieved within three hours. This is in stark contrast to conventional sintering temperatures that are around 1600° C. Furthermore, the ionic conductivity of the cold sintered sodium beta alumina at 300° C. is 7.6×10⁻³ S/cm, which is competitive with conventionally fired polycrystalline ceramics. Moreover, the grain size is on the order of the original powder particle size.

The disclosed processing technique circumvents all of the issues identified above regarding sodium beta alumina as a commercialized solid electrolyte. One advantage of the disclosed process is using low temperatures.

The disclosed process can be extended to larger areal membranes and used in any number of nascent energy storage technologies that would benefit from a stable solid electrolyte. Examples of such energy storage technologies include sodium-sulfur, sodium-NiCl, and metal-halide batteries. This process can also be used to reduce energy consumption during fabrication and exert microstructural control of polycrystalline sodium beta alumina membranes in a way that is presently unachievable with any other sintering technique. Furthermore, this technique can be applied to co-processing of the solid electrolyte membrane with solid electrodes in order to form coherently bonded solid-state batteries.

An exemplary method for fabricating a sintered sodium-ion material involves mixing a parent phase sodium-ion compound with a secondary transient phase to form a powder mixture. The method involves applying pressure and heat above a melting point or boiling point of the secondary transient phase to drive dissolution at particle contacts and subsequent precipitation at newly formed grain boundaries. The method involves generating a sintered sodium-ion material with >90% relative density.

In some embodiments, method involves forming a solid electrolyte membrane using the sintered sodium-ion material. In some embodiments, method involves forming a composite of β-alumina using the sintered sodium-ion material. In some embodiments, method involves forming a composite cathode using the sintered sodium-ion material.

In some embodiments, the parent phase sodium-ion compound is sodium beta alumina.

In some embodiments, the sodium beta alumina has an approximate composition of Na₁₊ₓ(MgₓAl₁₁₋ₓ)O₁₇ (x=0.67).

In some embodiments, the parent phase sodium-ion compound is a solid phase.

In some embodiments, the mixture is 10% wt. % of the secondary transient phase.

In some embodiments, the secondary transient phase is a non-aqueous transient solvent.

In some embodiments, the non-aqueous transient solvent is a hydroxide-based transient solvent.

In some embodiments, the heat applied is within a range from 250° C. to 500° C.

In some embodiments, the method involve a dwell time equal to or less than three hours.

In some embodiments, the pressure applied is within a range from 50 MPa to 400 MPa uniaxial pressure.

In some embodiments, the method involves applying heat and pressure simultaneously.

In some embodiments, the method involves annealing the sintered sodium-ion material

In some embodiments, the annealing involves subjecting the sintered sodium-ion material to a temperature within a range from 900° C. or 1200° C.

In some embodiments, the method involves improving electrical conductivity by reversing structural changes occurring during cold sintering by annealing the sintered sodium-ion material.

In some embodiments, the method involves removing intercalated water or generated carbonates by annealing the sintered sodium-ion material.

In some embodiments, the method involves forming a coherently bonded solid state battery by co-processing the sintered sodium-ion material into a solid electrolyte membrane and an electrode.

An exemplary embodiment relates to a solid state sodium-ion electrolyte membrane comprising a sintered sodium-ion material with >90% relative density.

In some embodiments, the sintered sodium-ion material comprises sodium beta alumina.

In some embodiments, the sodium beta alumina has an approximate composition of Na₁₊ₓ(MgₓAl₁₁₋ₓ)O₁₇ (x=0.67).

Further features, aspects, objects, advantages, and possible applications of the present invention will become apparent from a study of the exemplary embodiments and examples described below, in combination with the Figures, and the appended claims.

### BRIEF DESCRIPTION OF THE FIGURES

The above and other objects, aspects, features, advantages, and possible applications of the present invention will be more apparent from the following more particular description thereof, presented in conjunction with the following drawings. It should be understood that like reference numbers used in the drawings may identify like components.

FIG. 1 is an exemplary flow diagram of an embodiment of the sintering process.

FIG. 2 is an exemplary press and die set-up that may be used to carry out an embodiment of the process.

FIG. 3 shows XRD spectra of initial SBA powder and a cold sintered pellet.

FIG. 4 shows XRD spectra of characteristic 003 reflection of a conduction plane for SBA.

FIG. 5A shows an SEM image of an initial SBA powder.

FIG. 5B shows a representative area of a cold sintered fracture surface.

FIG. 5C shows a magnified image of well-sintered grains within a cold sintered pellet.

FIGS. 6A, 6B, and 6C show EIS spectrum of an as-cold-sintered pellet measured at room temperature (FIG. 6A), at 125° C. (FIG. 6B), and at 300° C. (FIG. 6C).

FIGS. 7A and 7B show conductivity as a function of inverse temperature for cold sintered and annealed samples alongside a representative set of prior work. The high temperature region of FIG. 7A is magnified in FIG. 7B.

FIG. 8A shows room temperature EIS spectra of as-cold-sintered SBA compared to cold sintered SBA annealed at 900° C. and 1200° C., and FIG. 8B shows a magnified view highlighting the more conductive annealed samples.

FIGS. 9A, 9B, and 9C show SEM images of the microstructure of an as-cold-sintered SBA sample (FIG. 9A) compared to that of a sample annealed at 900° C. (FIG. 9B), and 1200° C. (FIG. 9C).

FIG. 10A shows XRD spectrum for an initial powder, an as-cold-sintered, 900° C., and 1200° C. annealed SBA (β′ is marked with (*)).

FIG. 10B shows FTIR spectra for the SBA powder, an as-cold-sintered sample, and a cold sintered sample annealed at 1200° C. (CSP—Cold Sintering Process).

FIGS. 11A and 11B show ionic conductivity at 300° C. (FIG. 11A) and relative density (FIG. 11B) plotted as a function of peak sintering temperature for embodiments of a sintered material and a representative selection of prior art sintered material.

FIGS. 12A, 12B, 12C, and 12D show transmission electron microscopy of as-cold-sintered SBA, wherein low magnification images depict a dense microstructure (FIG. 12A) with some texturing throughout the overall microstructure (FIG. 12B), and high magnification images illustrate crystalline—amorphous interfacial regions at grain boundaries (FIG. 12C and FIG. 12D).

FIG. 13 shows a microhardness comparison chart between embodiments of the as-cold sintered alumina and other alumina products.

### DETAILED DESCRIPTION OF THE INVENTION

The following description is of an embodiment presently contemplated for carrying out the present invention. This description is not to be taken in a limiting sense but is made merely for the purpose of describing the general principles and features of the present invention. The scope of the present invention should be determined with reference to the claims.

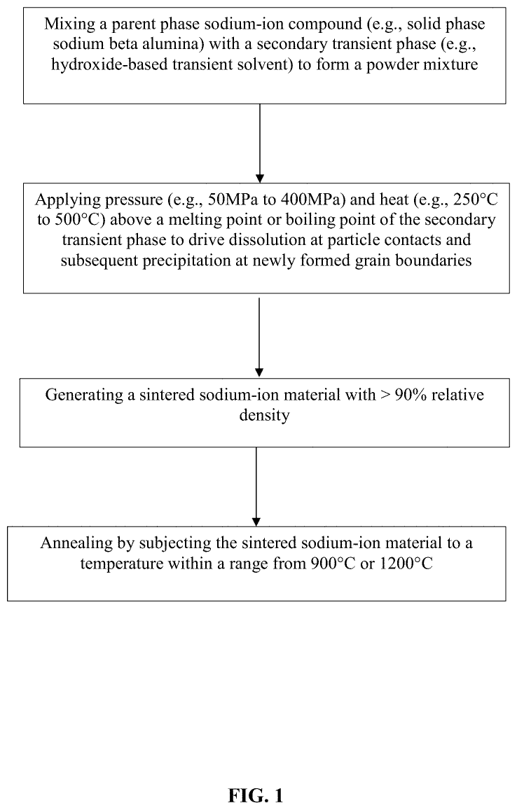

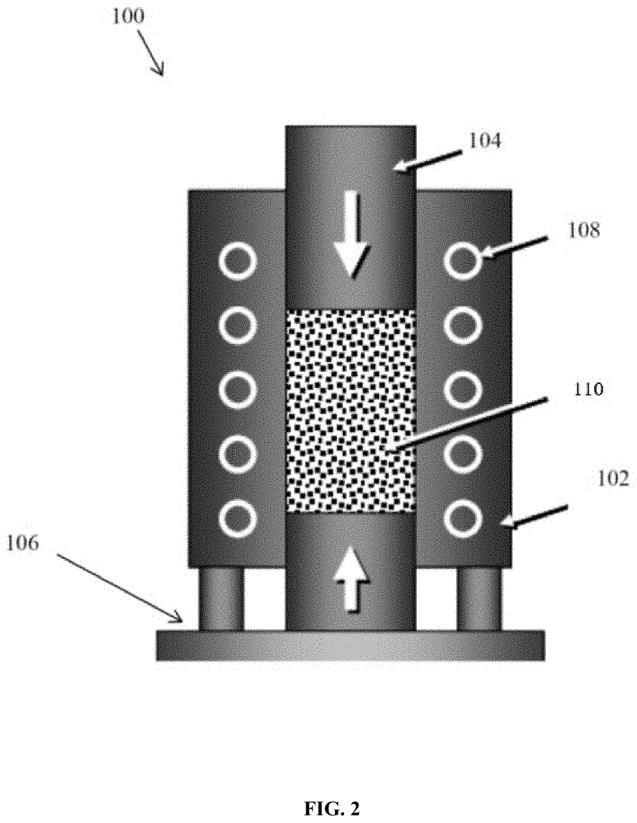

Referring to FIGS. 1-2, an exemplary method for fabricating a sintered sodium-ion material involves mixing a parent phase sodium-ion compound with a secondary transient phase to form a powder mixture 110. The parent phase sodium-ion compound can be sodium beta alumina. The sodium beta alumina can be in powder form. It is contemplated for the parent phase sodium-ion compound to be a solid phase. In an exemplary embodiment, the sodium beta alumina has an approximate composition of Na₁₊ₓ(MgₓAl₁₁₋ₓ)O₁₇ (x=0.67). It is contemplated for mixture 110 to comprise approximately 10% wt. % of the secondary transient phase. The secondary transient phase can be a non-aqueous transient solvent, which can include nitrates, bromides, iodides, etc. In an exemplary embodiment, the secondary transient phase can be a hydroxide-based transient solvent. The hydroxide-based transient solvent can be selected to partially solubilize the parent phase sodium-ion compound to form the mixture 110. In an exemplary embodiment, the hydroxide-based transient solvent is NaOH.

The method involves applying pressure and heat above a melting point or boiling point of the secondary transient phase to drive dissolution at particle contacts and subsequent precipitation at newly formed grain boundaries. Pressure can be applied at low temperatures to the mixture 110. The application of pressure and temperature leads to densification of the sodium-ion compound to form a sintered sodium-ion material, and also contributes to the removal of excess secondary transient phase via extrusion. It is contemplated for the heat applied to be within a range from 250° C. to 500° C. with a dwell time equal to or less than three hours. With other transient hydroxide solvents, the sintering temperature can be lowered even further. Preliminary work shows that relative densities of 89% can be attained at 200° C. using a KOH/NaOH eutectic mixture as a transient solvent. The conductivity of these samples is currently low relative to when a pure NaOH solvent but it is possible that the conductivity of these samples could be improved with annealing. It is contemplated for the pressure applied to be within a range from 50 MPa to 400 MPa uniaxial pressure. The heat and pressure can be applied simultaneously. The operating parameters and the materials described herein allow for generating a sintered sodium-ion material with >90% relative density.

In some embodiments, the method can be used to generate a sintered sodium-ion material on a substrate. For instance, the method can involve depositing sodium-ion compound onto a surface of a substrate. The substrate can be metal, ceramic, polymer, etc. The process can involve combining the sodium-ion compound, in particle form, with hydroxide-based transient solvent before, during, and/or after depositing the sodium-ion compound onto the surface of the substrate. The hydroxide-based transient solvent can be selected to partially solubilize the sodium-ion compound to form the mixture 110. Pressure can be applied at low temperatures to the mixture 110, leading to densification of the sodium-ion compound to form the sintered sodium-ion material on the substrate.

It should be noted that more than one substrate can be used (e.g., a layered structure or a laminate structure can be formed). For instance, the method can involve depositing sodium-ion compound onto a surface of a first substrate. The process can involve combining the sodium-ion compound, in particle form, with hydroxide-based transient solvent before, during, and/or after depositing the sodium-ion compound onto the surface of the first substrate. The hydroxide-based transient solvent can be selected to partially solubilize the sodium-ion compound to form the mixture 110. Pressure can be applied at low temperatures to the mixture 110, leading to densification of the at sodium-ion compound to form a sintered sodium-ion material on the first substrate. The method can involve forming a second substrate on the sintered sodium-ion material. The method can involve depositing the sodium-ion compound onto a surface of a second substrate. The process can involve combining the sodium-ion compound, in particle form, with hydroxide-based transient solvent before, during, and/or after depositing the at sodium-ion compound onto the surface of the second substrate. The hydroxide-based transient solvent can be selected to partially solubilize the sodium-ion compound to form the mixture 110. Pressure can be applied at low temperatures to the mixture, leading to densification of the sodium-ion compound to form a sintered sodium-ion material on the second substrate.

For the heating and pressure steps, the mixture 110 can be placed on a die 102 of a press 100. The press 100 can be a constant pressure hydraulic press, for example. The press 100 can be secured to a load frame with the die 102. The die 102 can be configured to receive and retain a volume of the mixture 110. The press 100 can be actuated to impart pressure onto the mixture 110 by advancing a hydraulic cylinder 104 towards the die 102. The die 102 and the load frame 106 can be configured to withstand the force of the hydraulic cylinder 104 so as to transfer the force to the mixture 110, thereby imparting pressure onto the mixture 110. The application of pressure can aid in the sintering of the metal particles while the solvent evaporates. A heater band 108 can be coupled to the die 102, and be connected to an electrical power source for applying the heat to the die 102, which is transferred to the mixture 110 when the mixture 110 is placed therein. The application of heat can cause the solvent to evaporate, supersaturate any solubilized species, and densify the sodium-ion compound to form the sintered sodium-ion material.

Some embodiments involve annealing the sintered sodium-ion material. The annealing can involve subjecting the sintered sodium-ion material to a temperature within a range from 900° C. or 1200° C. by placing the sintered sodium-ion material into an annealing oven for a predetermined amount of time. The annealing can improve ionic conductivity by reversing structural changes occurring during cold sintering. In addition, the annealing can remove intercalated water or generated carbonates.

It is contemplated for the sintered sodium-ion material to be used as a component for a solid electrolyte membrane. For instance, a battery can include a cathode electrode, a solid electrolyte membrane, and an anode electrode. The cathode electrode and/or the anode electrode can be liquid or gas. The membrane can be made from an embodiment of the sintered sodium-ion material. The entire solid electrolyte membrane can be made of sintered sodium-ion material, or only a portion thereof.

Some embodiments can involve forming a coherently bonded solid state battery by co-processing the sintered sodium-ion material into a solid electrolyte membrane and an electrode. As an exemplary embodiment, the solid-state battery can be comprised of at least three layers; a solid cathode, a solid electrolyte membrane, and a solid anode. In the case of a solid-state battery comprised of solid layers, good electrochemical performance is contingent on effective charge transfer across the interfacial layers. Thus, a high degree of contact between the solid layers is desirable, as this facilitates efficient charge transfer. The disclosed cold sintering process can be applied to all three layers simultaneously, thereby forming a dense membrane which is bonded to the solid electrode layers. This would be impossible with conventional solid-state sintering owing to the high temperatures which would degrade the solid electrodes during sintering.

### Examples

The disclosed cold sintering process is successfully applied to one of the most refractory solid-state sodium-ion electrolytes, namely sodium beta alumina (SBA). By using a hydroxide-based transient solvent, SBA is densified below 400° C., whereas conventional solid-state sintering is known to require sintering temperatures around 1600° C. This dramatic reduction in sintering temperature (ca. Tₛᵢₙₜₑᵣ˜20% of Tₘ) can be achieved by cold sintering with the addition of 10 wt. % solid NaOH transient phase, 360 MPa of uniaxial pressure, and heating to 350-375° C. for a dwell time of three hours. The resulting pellets exceed 90% of the theoretical density for SBA and exhibit ionic conductivities of ˜10⁻² S cm⁻¹ at 300° C., as measured by electrochemical impedance spectroscopy. The structural changes occurring during cold sintering are reversed with an intermediate temperature annealing step (ca. 1000° C.) which improves the ionic conductivity.

Sodium β″-alumina (SBA) is one of the few commercialized solid-state alkali ion electrolytes, despite decades of research conducted on such materials. The SBA electrolytes have been successfully integrated into high temperature secondary batteries with liquid electrodes, the chemistries of which include Na|S and Na|NiCl (also referred to as “ZEBRA” batteries). SBA is well-suited for these applications owing to its excellent stability under such conditions while maintaining high ionic conductivity at elevated temperatures (e.g., >1 mS cm⁻¹ at 300° C.), in contrast to other well-studied solid-state sodium ion electrolytes, such as NASICON-structured Na₃Zr₂Si₂PO₁₂, which tend to be unstable at higher temperatures and in contact with alkali metals. The coupling of high temperature stability and highly anisotropic ionic conductivity are a consequence of the SBA structure; the mobile sodium ions are confined within conductive two-dimensional planes (e.g., basal planes), separated from one another by strongly bonded layers of refractory spinel-Al₂O₃. The ionic conductivity in the other principle directions of the structure is effectively negligible, so there must be complex tortuous pathways within the microstructure of β″-Al₂O₃.

These strongly bonded alumina layers are responsible for the excellent thermal and chemical stability of the sintered bulk ceramics, but they also require unusually high sintering temperatures (typically ≥1600° C.) in order for the densification process to proceed. These notably high sintering temperatures introduce a number of issues in the processing of SBA, including but not limited to: (1) loss of sodium due to volatilization, (2) thermally induced phase transformation from the β″-phase to the less conductive β′-phase, and (3) abnormal/excessive grain growth during prolonged dwell times at peak sintering temperatures, resulting in poor mechanical properties in the final polycrystalline ceramics. SBA, thus illustrates an unfortunately common dichotomy in solid-state ionic conductors; their structures are characterized by both light, mobile, ions (e.g. Li⁺, Na⁺) and a strongly bonded, rigid, framework (e.g. spinel Al₂O₃), such that the high sintering temperatures required by the latter result in a loss of control over the former. For these reasons, it is of great interest to the ceramics community to reduce the peak sintering temperature of electroceramics, even if the synthesis/calcination temperature of the powder remains relatively high.

The issues associated with conventional high temperature sintering of SBA have been known for many decades. The undesired β″ to β′ phase transformation can be mitigated by stabilizing the β″ phase via doping with Li₂O or MgO, but this introduces processing and structural complexities. Aliovalent doping and sodium loss can be avoided by substituting the solid-state reaction synthesis process with a vapor-phase synthesis process, where a composite of yttria-stabilized zirconia (YSZ) and a-Al₂O₃ is first synthesized and sintered (ca. 1600° C.) followed by post-sintering calcination of the sintered ceramic in the presence of a sodium source, resulting in the formation of a β″-alumina/YSZ composite. These composites are highly conductive and strong but contain a large volume fraction (ca. 30 vol. %) of non-conductive YSZ which is required for oxygen diffusion during the conversion reaction.

Alternatively, the sintering process itself can be modified to promote sintering at lower temperatures. Liquid phase sintering utilizing sintering additives such as TiO₂ have been shown to lower the sintering temperature to 1400° C., while retaining relatively high conductivity in the fine-grained SBA. Hot pressing has also been shown to reduce the sintering temperature of SBA to 1100° C., but the process is very intensive and the varies in effectiveness. Most recently, field-assisted sintering techniques such as Spark Plasma Sintering (SPS) have been shown to lower the sintering temperature of SBA to 1300° C. while also offering a high degree of control over the orientation of the grains within the polycrystalline ceramic. Microwave-assisted sintering has also been recently applied to SBA. These techniques all exploit unique combinations of driving forces for sintering (e.g., applied pressure, capillarity) and demonstrate unique advantages, however none of these techniques has been shown effective in achieving any degree of densification below 1100° C.

Cold sintering is an emerging alternative sintering technique which involves the mixing of the parent phase, SBA in this case, and a secondary transient phase. The powder mixture is then simultaneously pressed and heated above the melting or boiling point of the transient phase, which is thought to drive dissolution at particle contacts and subsequent precipitation at newly formed grain boundaries. The combination of these multiple driving forces (temperature, pressure, chemical reactivity) has been shown to reduce the sintering temperature of a gamut of ceramics from the conventional solid-state sintering regime (ca. 70% of Tₘ) to only hundreds of degrees Celsius (ca. 25% of Tₘ). This technique has been of particular interest for ceramic ion conductors given the previously described sintering dichotomy and the desire to co-process electrochemical ceramics with other, thermally fragile, conductive additives. Furthermore, large reductions in sintering temperature have the potential to significantly reduce the energy used during sintering and expedite decarbonization process of the ceramics industry.

It has been recently shown that an application of cold sintering to NASICON-type solid-state sodium ion electrolyte, Na₃Zr₂Si₂PO₁₂, reduces sintering temperature of the ceramic from over 1200° C. to under 400° C. when a solid hydroxide transient phase is used. The sodium hydroxide (NaOH) solid hydroxide transient phase was introduced as a powdered salt and proved much more effective in promoting cold sintering relative to cold sintering driven by a concentrated solution of NaOH and H2O. Techniques disclosed herein extend this approach to an even more refractory solid-electrolyte, SBA. Until now, cold sintered ionic conductors have usually required conductive additives, such as salts or polymers, to improve the ionic conductivity.

### Examples

Mg-stabilized SBA having an approximate composition of Na₁₊ₓ(MgₓAl₁₋ₓ)O₁₇ (x=0.51, estimates from electron dispersive spectroscopy) was purchased from MSE Supplies. Sodium hydroxide powder (97% purity) was purchased from Sigma Aldrich. All powders were stored under vacuum at 80° C. when not in use.

Cold sintering with a hydroxide transient solvent was described previously. Briefly, the NaOH and SBA were weighed and mixed by hand in a fume hood. The powder mixture was then loaded into a stainless-steel die (inner diameter of 13 mm) with nickel foil (99%, Alfa Aesar) separators between the powder and the punch faces. The die was then inserted into a band heater, affixed with a thermocouple, and loaded into a carver press equipped with heated platens and with the temperature and pressure applied simultaneously. Once the dwell time was complete, the temperature controller was switched off and the pressure was released naturally with cooling. The pellets were then removed and stored under vacuum.

The SBA pellets were mechanically polished with silicon carbide grinding paper after sintering or before heat treatment prior to any characterizations. The density of the pellets was assessed both geometrically (via volume and mass measurements) and with Archimedes method using ethanol as a solvent. For pellets above 90% relative density, both methods agreed well (i.e., ±3% agreement). Pellet dimensions were typically 0.7 to 1.0 mm in thickness and 13.0 mm in diameter.

X-Ray diffraction (PANalytical Empyrean, Cu Kα) was conducted on polished pellet surfaces in a Bragg-Brentano configuration with a tension of 45 kV, current of 40 mA, step size of 0.01°, and dwell time of 200 s step⁻¹ over a range of 5° to 70°. Pellets of cold sintered SBA were sputtered with ion-blocking platinum electrodes (Kurt J. Lesker, approximate area of 0.2 cm², 100 nm thick) with a Quorum Technologies sputter coater (EMS 150R-S) for electrical measurements. Electrochemical impedance spectroscopy (EIS, Modulab XM MTS) was taken from 1 MHz to 0.1 Hz with an AC amplitude of 10 mV. EIS was measured from room temperature to 350° C. with a thermal soak time of 20 minutes per temperature. EIS fitting was conducted using ZView software (Scribner Associates). Scanning electron microscopy (SEM, FESEM Verios NanoSEM) was conducted on fracture surfaces of pellets coated with 6 nm of iridium with an accelerating voltage of 3 kV. Transmission electron microscopy was carried out under cryogenic conditions using a Talos F200X (FEI) microscope equipped with a Gatan cryogenic holder in both dark field and scanning mode (STEM) at an accelerating voltage up to 200 kV. Chemical mapping was performed with a SuperEDX detector. The TEM samples were prepared by Ga+ focused ion beam milling (Helios 660, FEI).

Fourier transform infrared (FTIR) spectra were collected using a Vertex 70 spectrometer (Bruker, Mass., USA) equipped with a liquid nitrogen-cooled narrow-band MCT detector and a Harrick Praying Mantis™ Diffuse Reflectance Infrared Fourier Transform spectroscopy (DRIFTs) cell (Harrick Scientific Products, Inc., NY, USA). To minimize the impact of air exposure prior to DRIFTS experiments, β-Al₂O₃ samples were dried at 80° C. under vacuum, then moved into transportable vacuum boxes a few minutes before the measurement. Pieces of β″-Al₂O₃ pellets were ground and mixed with (spectroscopy grade) anhydrous KBr (with a 3:97 mass ratio). The mixture was then carefully poured in a conical sample holder. Spectra were collected at room temperature and are an average of 100 scans in the 400-4000 cm⁻¹ wavenumber range. The background correction was performed with the infrared signal of pure KBr. Afterwards, FTIR spectra were normalized and analyzed using the spectroscopy software OPUS.

Some pellets were subjected to a post-annealing process in a flowing argon atmosphere inside a tube furnace a various temperatures for three hours with a thermal ramp rate of 3° C. and cooling rate of 1° C. Prior to annealing, the sample surfaces were polished such that the platinum electrodes could be applied immediately after removal from the furnace.

The cold sintering parameters from previous studies using similar flux systems was found to be effective in the case of SBA as well. These conditions were 10 wt. % (14.6 vol. %) of pure sodium hydroxide (NaOH) powder mixed into 90 w % (85.4 vol. %) of the parent SBA powder, which was then pressed at 360 MPa and heated to 375° C. and held for three hours. The relative density was found to be constant for 8 wt % to 12 wt % NaOH, while weight fractions of NaOH outside of this range resulted in poor densification. All powders were stored under vacuum and in the presence of desiccant to minimize moisture absorption from the atmosphere. With these conditions, densities of 3.04±0.09 g cm⁻³ (92.7±2.70%) were reproducibly achieved. The mutual effectiveness of these conditions on such dissimilar materials (SBA and Na₃Zr₂Si₂PO₁₂) is likely due to both the reduced propensity for incongruent leeching of sodium during sintering, as well as the increased solubility of oxides under pressurized molten hydroxide conditions.

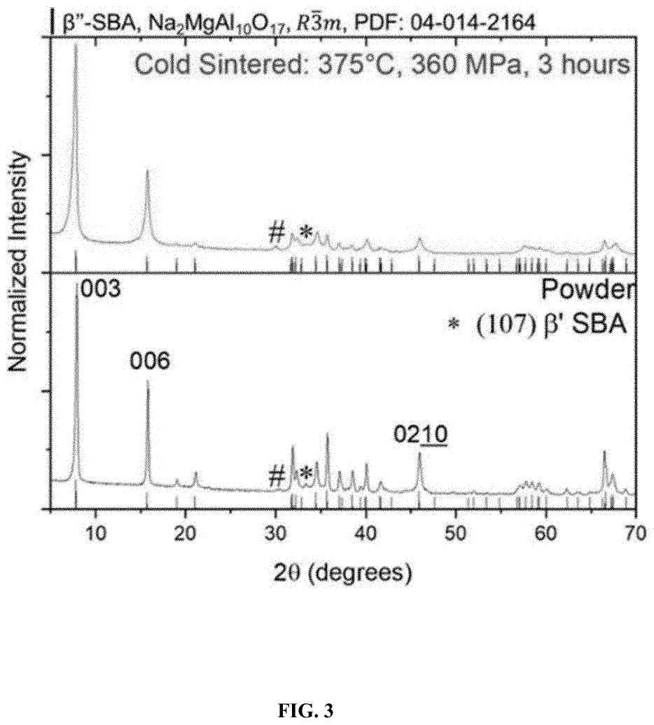

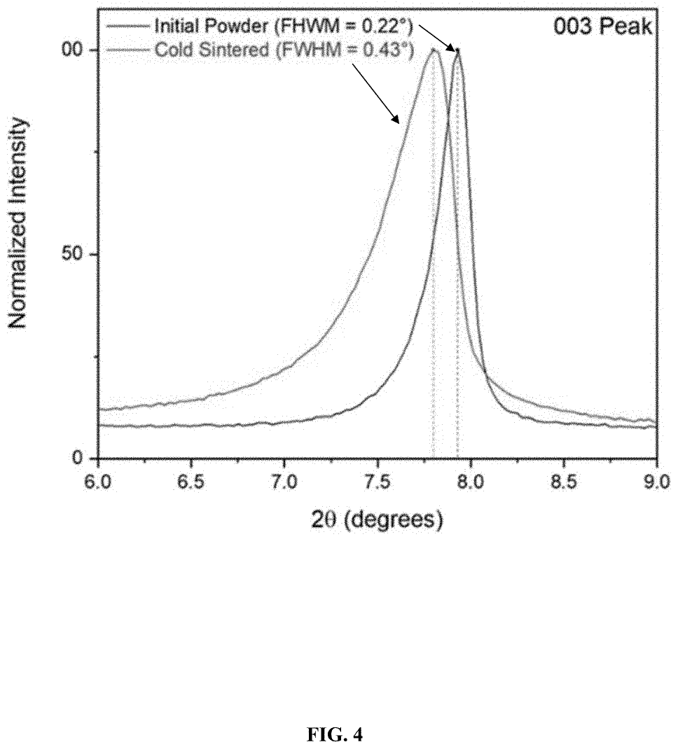

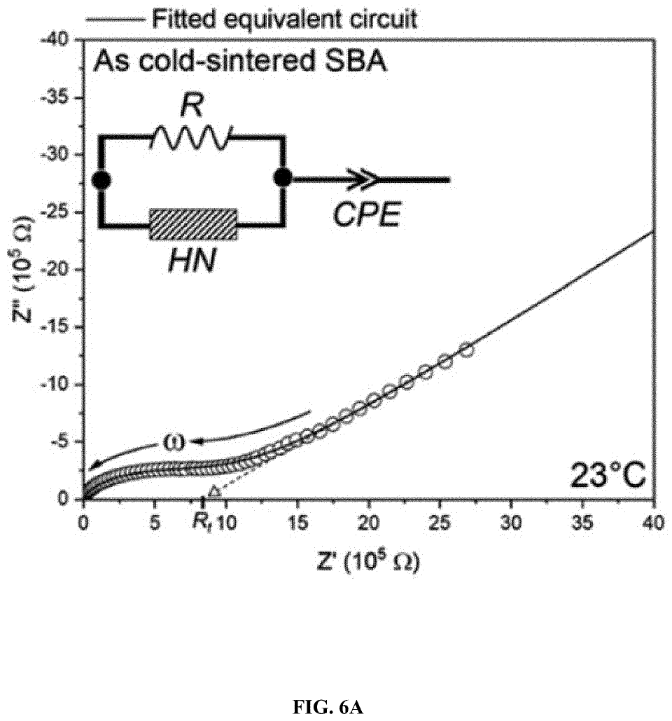

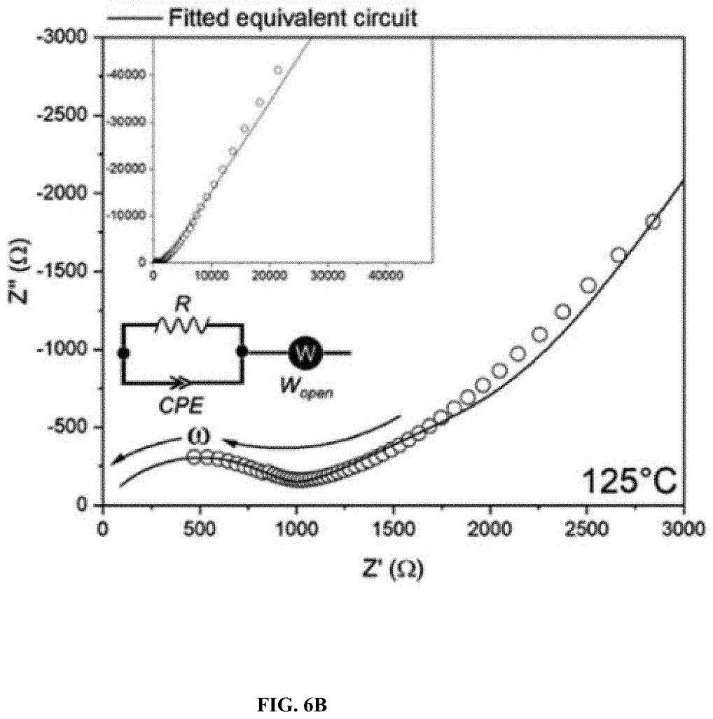

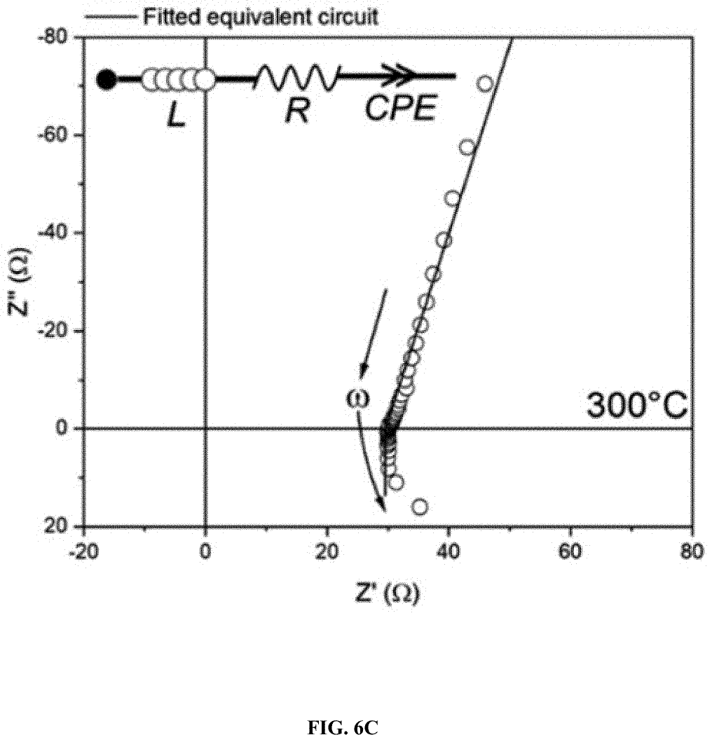

FIGS. 6A, 6B, and 6C show XRD spectra of the initial SBA powder and a cold sintered pellet. FIG. 4 shows XRD spectra of the characteristic 003 reflection of the conduction plane for SBA. (*) denotes the (3′ SBA phase. (#) denotes a secondary, unidentified impurity. FWHM=Full Width Half Maxima. Reference β″-SBA structure: PDF 04-014-2164. X-ray diffraction (XRD) was performed on a representative cold sintered pellet (10 wt. % NaOH, 375° C., 360 MPa, 3 hours) to assess the phase purity. FIG. 3 depicts a typical XRD pattern of such a pellet alongside an XRD spectra for the initial powder. The powder is primarily comprised of the highly conducting β″ phase (SBA, rhombohedral, R3̅m) and a small amount of the less-conductive β′ phase (SBA′, hexagonal, P6₃/mmc), the latter deduced from the small peak at 33.5°. Previous studies have estimated the relative amount of SBA versus SBA′ by comparing the height of characteristic peaks for each phase, but it should be noted that the results can vary based on the SBA stabilizing dopant, specific peak couple selected, and reference structure chosen. In the present case, the intensity of the (021̅0̅) β″ reflection (I_{β″}) is compared to that of the (107) β′ reflection (I_{β′}) with the equation,

$$f ( {β}^{″} ) \% = ( 1 - \frac{{I}_{{β}^{′}}}{{I}_{{β}^{″}}} ) * 100 \%$$

From this estimation, the powder is comprised of about 90% of the β″ phase. Besides this sizable fraction of β′, all other XRD peaks can be indexed with the R3̅m β″ SBA phase (PDF 04-014-2164). The full XRD spectra of the cold sintered pellet is very similar to that of the initial powder (see FIG. 3). The primary conduction layer peaks ((003), (006)), are broader and slightly shifted relative to the powder spectra. A decrease in peak sharpness, especially at the high angles, may indicate some loss of long-range order but may also be due to the reduced intensity arising from the spectra of a polished pellet compared to fine powder. The only additional peak which cannot be indexed to the β″ phase is at approximately 29.0° 2Θ (marked ‘#’ in FIG. 3) which is presently unidentified. This peak is also present in the initial powder, albeit with very low intensity, suggesting that this phase is not primarily generated during the cold sintering process.

Interestingly, the (107) β′ peak is not as prominent in the XRD spectra of the cold sintered pellet relative to the initial powder. The background of the cold sintered XRD pattern is higher (normalized to 003-peak height) relative to the powder, so the β′ phase may lie below the detection limit. However, this result does indicate that very little, if any, β′ SBA is generated during the cold sintering process.

Upon closer inspection of the primary (003) peak (see FIG. 4), it is apparent that the peak location and shape of the cold sintered ceramic differ significantly from the initial powder. The location of the peak is shifted to a higher angle, in this case by 0.13° 2θ, and the peak takes on a more asymmetric decay profile relative to the powder.

Symmetric broadening of peaks in XRD spectra is a common phenomenon often associated with decreased crystallite size, whereas asymmetric peak broadening much less commonly observed. Prior work has shown that diffusion of water into the conduction plane of SBA results in the expansion of the c-axis by about 1%, which is similar to the shift in (003) Bragg angle observed here (ca. 1.6% expansion). It has also been previously shown that the diffusion of water into the conduction plane is inhomogeneous, with the surface of sintered pellets (a depth of ˜5 μm) being particularly susceptible and is often coupled with a formation of sodium carbonates. Thus, the asymmetric peak broadening coupled with a small lattice expansion appears to suggest a similar reaction with water in the cold sintered samples. It will be shown later that this is reversible with an annealing step.

Two other aspects of the XRD spectra suggest a water absorption and carbonate formation during cold sintering. First, the primary conduction plane peak (003) is shifted by 0.13° 2θ, indicating an expansion of about 1.6%. Second, it is noted that the broadening of the (003) peak (full-width-half-maxima increases by 0.21°) is unevenly distributed, i.e. the peak broadens asymmetrically after cold sintering. The conduction plane expansion is consistent with the intercalation of water molecules, which displaces sodium ions to the surface of the ceramic, resulting in the simultaneous formation of Na₂CO₃. These reactions are known to proceed readily upon exposure to air, so the procession of the reaction during cold sintering (in ambient atmosphere) is unsurprising. It is worth noting that the conventional solid state sintering process of SBA requires temperatures greater than 1400° C., which is more than sufficient to decompose Na₂CO₃ and expel any intercalated water. Thus, while cold sintering dramatically reduces the sintering temperature, the cold sintering temperature is insufficient to remove the carbonates/water molecules. An intermediate temperature annealing step is therefore required.

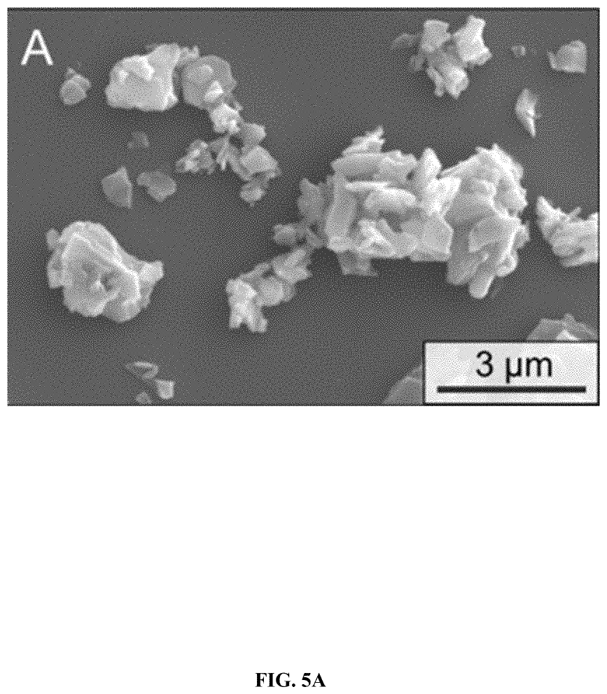

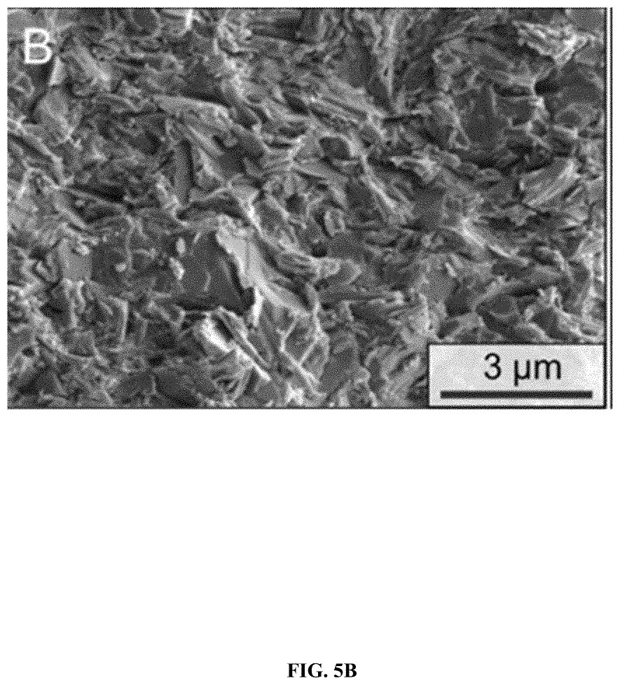

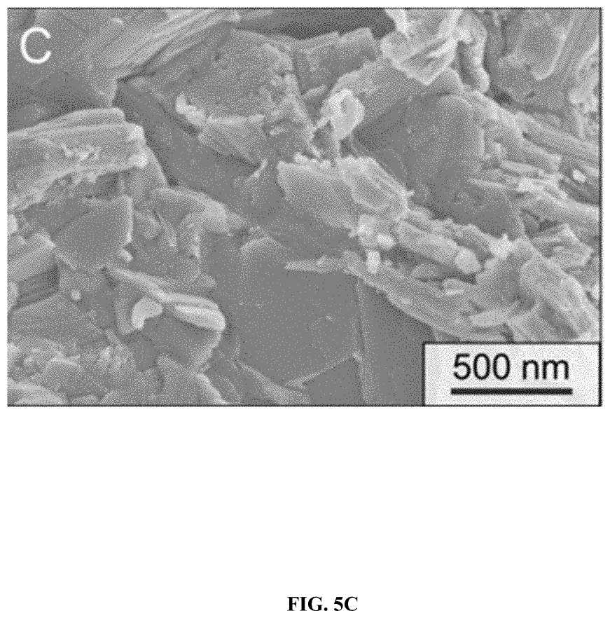

FIG. 5A shows an SEM image of an initial SBA powder, FIG. 5B shows a representative area of a cold sintered fracture surface, and FIG. 5C shows a magnified image of well-sintered grains within the cold sintered pellet. Scanning electron microscopy (SEM) was performed to confirm the density measurements. The initial powder (see FIG. 5A) exhibits the characteristic platelet morphology of the layered SBA. The particle size ranges from about 1 to 5 μm. A representative image of a fracture surface from a cold sintered pellet is shown in FIG. 5B. The lack of any significant porosity in the bulk microstructure is a clear confirmation of the high relative density.

Higher magnifications of the cold sintered microstructure (see FIG. 5C) illustrate the formation of well-sintered grain boundaries within the cold sintered SBA ceramic. The individual grains retain the hexagonal platelet crystal habit of the initial powder. The sintered grains are approximately the same dimensions as the original powder, implying a lack of grain growth during the cold sintering of SBA. Well-faceted grain boundaries can clearly be observed at high magnifications (see FIG. 5C), indicating that a sintering process has occurred. Collectively, these observations prove that cold sintering can be applied to SBA to produce dense microstructures which retain the grain size of the initial powder, thus avoiding the exaggerated grain growth phenomena frequently observed in conventional sintering processes. The fine-grained cold sintered SBA pellets are mechanically strong and difficult to fracture by hand.

Elemental mapping provides direct evidence for the presence of sodium carbonates on the surface of the as-cold-sintered SBA samples. It is noted that the applied uniaxial pressure appears to induce some microstructural texturing perpendicular to the direction of applied pressure (Lotgering analysis). Texturing has been previously observed in spark plasma sintered SBA, albeit to a much higher degree, which resulted in the conductivity of the sample becoming magnified by a factor of about 2.5. However, this effect should be small relative to other factors such as secondary phases and relative density in the cold sintered SBA samples.

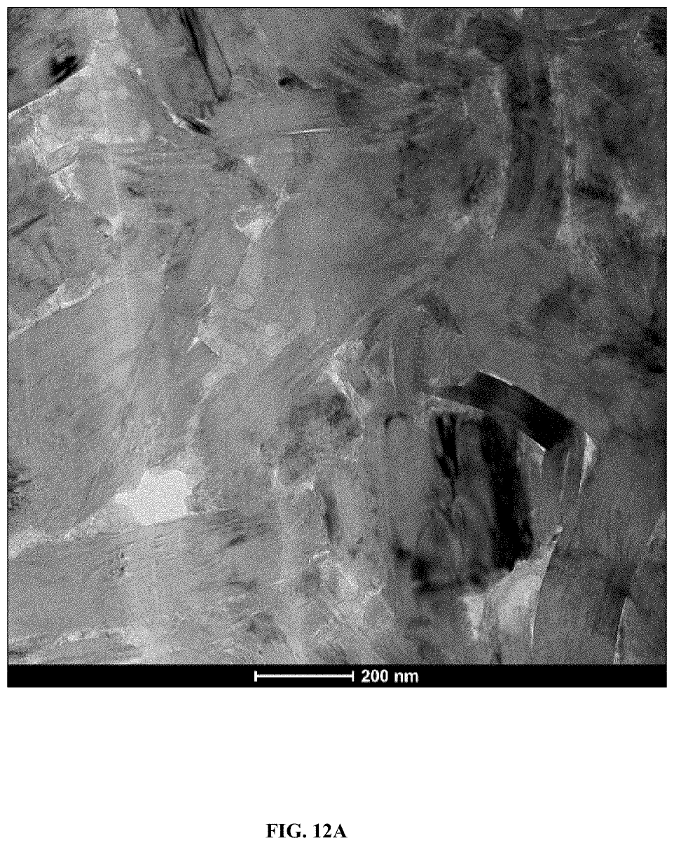

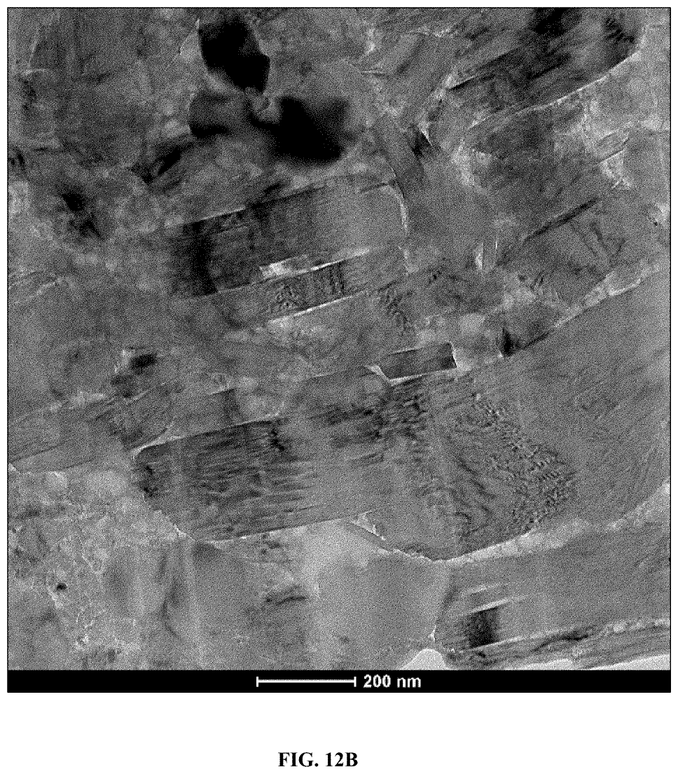

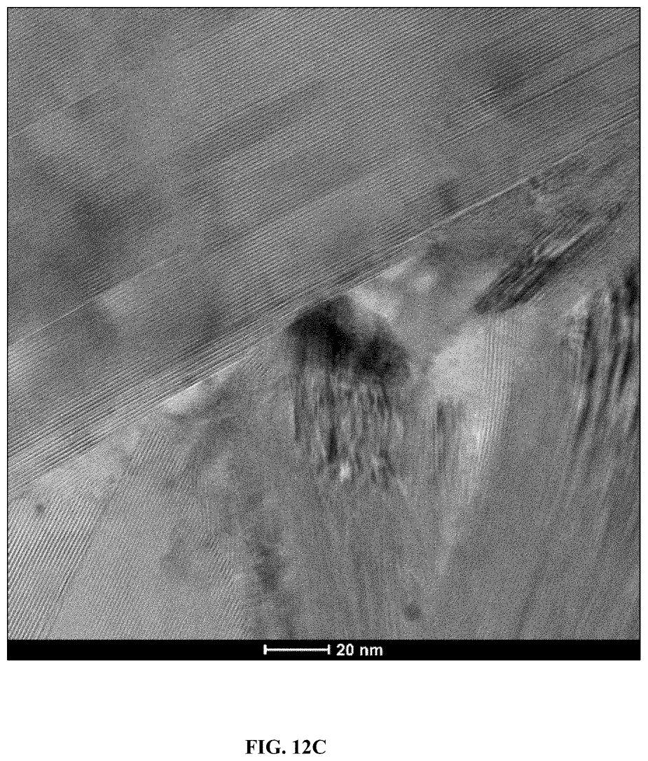

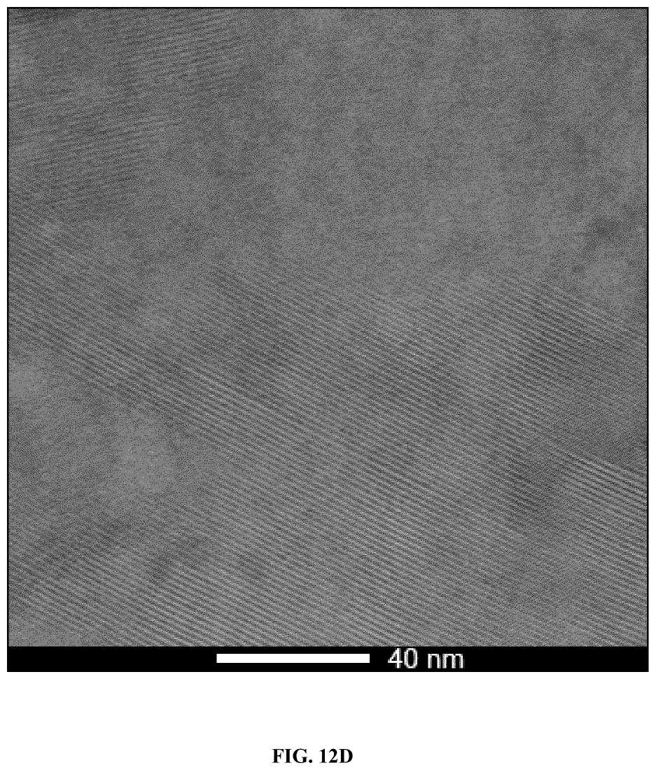

To investigate the microstructure of the as-cold-sintered in more detail, cryogenic transmission electron microscopy was performed (see FIGS. 12A-12D). It should be noted that fast ionic conductors such as SBA are difficult to probe with transmission electron microscopy due to beam degradation when cryogenic conditions are not employed. In FIGS. 12A and 12B, the dense microstructure of the cold sintered beta alumina can be clearly observed. Despite the high aspect ratio of the SBA crystal habit (elongated platelet), few pores are present in the microstructure owing to the grain rearrangement and grain boundary formation during cold sintering. Moreover, certain regions appear to contain grains which exhibit texturing in the form of the platelet-shaped grains stacking upon one another with aligned c-axes (see FIG. 12 B). This is consistent with the aforementioned Lotgering analysis.

Closer inspection of the TEM micrographs sheds light on the grain boundary regions (see FIGS. 12C and 12D). The grain boundary regions in the cold sintered SBA are generally amorphous and span distances on the order of 10 to 20 nanometers. Chemical mapping of the grain boundary regions confirms their chemical similarity to the adjacent crystalline grains, suggesting that the amorphous grain boundary regions are the result of the dissolution-precipitation process driven by cold sintering. The amorphous regions fill the irregularly shaped intergranular spaces which explains how relative densities of >90% are obtained without significant grain growth for a microstructure of platelet-shaped SBA grains, which cannot pack efficiently compared to isotropic grains. Upon annealing, these amorphous regions likely crystallize into similarly high aspect ratio grains and evolve porosity in the process owing to the packing limitations imposed by the irregular grain morphology. Some evidence of a terrace— ledge structure exits at the edges of some grains adjacent to intergranular amorphous regions (see FIG. 12D), which may suggest that the dissolution—precipitation process during cold sintering occurs preferentially along certain crystallographic directions, such as the edges of the platelets (e.g., (0110)) compared to the basal plane (003).

The relationship between the ionic conductivity and grain/grain-boundary structure in SBA has been a subject of debate for many decades. Numerous authors have proposed contrasting microstructural models to account for the anisotropic conduction properties of conventionally fired SBA, which account for abnormal microstructural factors by introducing concepts such as “easy” conduction paths through grains of varying levels of misorientation, among other effects. Inherent complexity of a polycrystalline arrangement of an anisotropic ion conducting ceramic can only be magnified by the contributions from the complexity in grain boundary regions. These grain boundary regions in cold sintered SBA reflect the non-equilibrium nature of the low temperature sintering process compared to conventional sintering, which, owing to the high sintering temperature, produce microstructures much closer to the thermodynamic equilibrium state.

FIGS. 6A, 6B, and 6C show an EIS spectrum of an as-cold-sintered pellet measured at room temperature (FIG. 6A), at 150° C. (FIG. 6B), and at 300° C. (FIG. 6C). The spectra of FIG. 6B is fitted with the inset equivalent circuit to deconvolute the noted resistance contributions. Discrete points represent experimental data, and solid lines denote the equivalent circuit fitting. The frequency is indicated with the color gradient shown in the inset of FIG. 6A. The ionic conductivity of the cold sintered SBA pellets was then measured with electrochemical impedance spectroscopy (EIS). When plotted in the complex plane (Z″ versus Z′), a partial semicircle followed by a low frequency Warburg-type electrode response is observed, which is characteristic of polycrystalline ionic conductors with blocking electrodes. From such complex plane plots, it is possible to calculate the frequency-independent resistance from extrapolation of the linear electrode response to the Z′ axis intercept, as indicated in FIG. 6A. This total resistance, denoted Rₜ, can then be used to calculate the total conductivity, σₜ,

$${σ}_{t} = \frac{t}{{R}_{t} * A}$$

where t and A are the sample thickness and electrode area, respectively. In this way, it is found that the cold sintered SBA samples typically have room temperature conductivities of around 3.4*10⁻⁷ S cm⁻¹. Conventionally sintered polycrystalline Mg-stabilized SBA typically has room temperature conductivity values on the order of 10⁻³ S cm⁻¹. The high resistance of the cold sintered SBA at room temperature is likely due to the non-conductive Na₂CO₃ and intercalated water. This room temperature conductivity is improved upon by further annealing, as is shown herein.

As the temperature is increased, the impedance of the samples decreases quickly (see FIG. 6B). The shape of the semicircle formed in the complex plane also changes from asymmetric at low temperatures (see FIG. 6A) to a somewhat suppressed, symmetrical semicircle at 150° C. (see FIG. 6B). The impedance spectra at 1250° C. is fit with a common equivalent circuit (see FIG. 6B, inset) in which ca resistor and a constant phase element (CPE) are placed in parallel to capture the grain boundary response, followed in series by a linear CPE to capture the electrode polarization. The total conductivity at 125° C. for the cold sintered SBA is 1.07×10⁻⁴ S cm⁻¹.

At 300° C. (see FIG. 6C), the Impedance spectrum is characterized simply by a straight line from the electrode, with some inductance at the highest frequencies. The inductance is likely due to contributions from the electrode and silver wires in addition to some closed porosity which has been previously observed in conventionally sintered SBA. Taking Rₜ to be the high frequency intercept with the Z′ axis, the conductivity of the as-cold sintered SBA at 300° C. is found to be 7.6*10⁻³ S cm⁻¹.

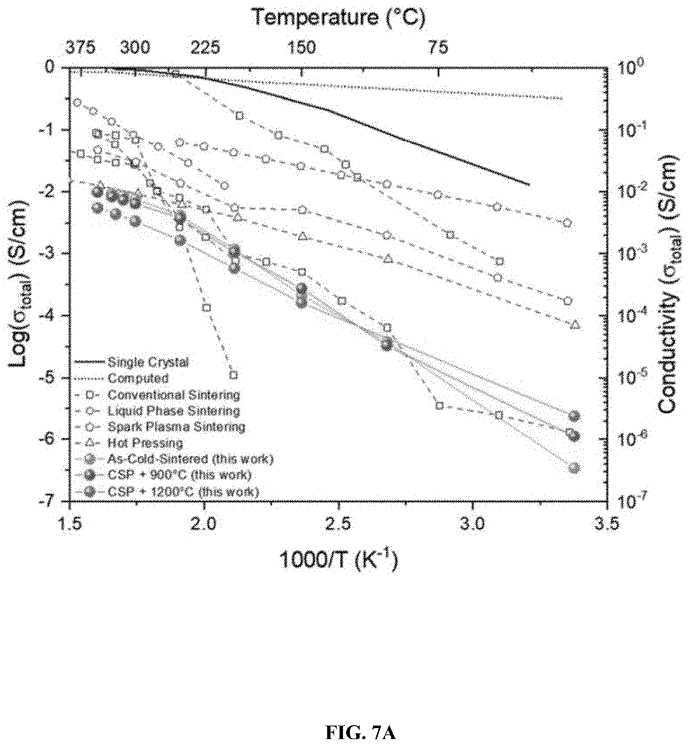

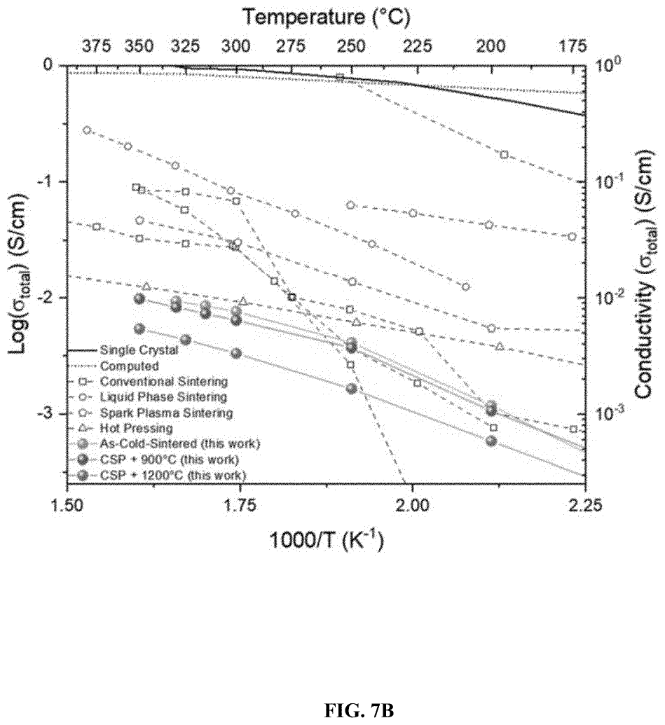

FIGS. 7A and 7B show conductivity as a function of inverse temperature for cold sintered and annealed samples alongside a representative set of prior work. The high temperature region of FIG. 7A is magnified in FIG. 7B. Data from the literature includes computationally calculated conductivity, single crystal measurements, conventionally sintered polycrystalline SBA liquid phase sintered SBA, spark plasma sintered SBA, and hot pressed SBA. In FIGS. 7A and 7B, the total conductivity (derived from Rₜ) versus inverse temperature is plotted alongside a collation of data from the literature. From this Arrhenius plotting, it is clear that high temperature (T˜300° C.) conductivity of the cold sintered SBA (7.6*10⁻³ S cm⁻¹) is within the lower boundary of the range of conductivity values reported for SBA requiring temperatures more than 1000° C. greater than the cold sintering temperature. At lower temperatures, (ca. T<200° C.) the conductivity of the cold sintered SBA is lower than most previous reports, however, it should be noted that there is significantly more non-Arrhenius behavior and a wider range of reported conductivities for other processing methods within this lower temperature window.

The activation energy of at these lower temperatures (ca. 23° C. to 250° C.) is higher for the as-cold-sintered SBA (0.54 eV) than the conventionally sintered SBA (ca. 0.3 eV). However, at temperatures above 250° C., the activation energy of the cold sintered SBA changes to 0.20 eV, which is consistent with previous studies. This can be more easily seen by enlarging the high temperature portion of the Arrhenius plot (see FIG. 7B) and by comparing the electrical properties these cold sintered samples with a representative set of conventionally processed polycrystalline SBA (see Table 1).

TABLE 1
A compilation of other studies relating to the sintering of SBA and the resulting properties.

| | | Sintering | | | [symbol] for | Relative | |
|---|---|---|---|---|---|---|---|
| | | temperature | σ at 300° C. | σ at 23° C. | T [symbol] | density | |
| Reference | Method | (° C.) | (S cm [symbol] ) | (S cm [symbol] ) | 200° C. (eV) | (%) | Comment |
| This work | CSP | 373 | 7.6 × 10⁻ [symbol] | 3.40 × 10⁻ [symbol] | 0.22 | 92.7 | |
| This work | CSP + 900° C. | 900 | 6.4 × 10⁻ [symbol] | 1.12 × 10⁻ [symbol] | 0.26 | 89.6 | |
| This work | CSP + 1200° C. | 1200 | 3.2 × 10⁻ [symbol] | 5.22 × 10⁻ [symbol] | 0.31 | 83.8 | |
| 59 | Computed | — | 1.0 × 10 [symbol] | — | — | — | Interpolated |
| 60 | Single crystal | — | 3.5 × 10⁻ [symbol] | — | 0.03 | — | Interpolated |
| 61 | CS | 1550 | 2.8 × 10 [symbol] | — | 0.23 | 75 | |
| 62 | CS | 1620 | 8.0 × 10⁻² | — | 0.51 | 96 | σ at 250° C. |
| 63 | CS | 1600 | 6.8 × 10⁻² | 1.32 × 10⁻ [symbol] | 0.15 | 98.5 | |
| 64 | CS | 1600 | 2.8 × 10⁻² | — | — | 98.5 | |
| 19 | LPS | 1520 | 8.4 × 10⁻² | — | 0.15 | 98.2 | 1 mol % [symbol] |
| 24 | SPS | 1 [symbol] 00 | 3.0 × 10⁻² | 1.74 × 10⁻ [symbol] | 0.38 | 96.4 | |
| 26 | SPS | 1400 | 6.3 × 10⁻² | 3.16 × 10⁻ [symbol] | 0.17 | 98.9 | σ at 250° C. |
| 22 | Hot pressing | 1700 | 9.1 × 10⁻ [symbol] | 6.96 × 10⁻ [symbol] | 0.19 | 99 | |

Abbreviations [symbol]
CSP—cold sintering process.
CS—conventional sintering.
LPS—liquid phase sintering.
SPS—spark plasma sintering [symbol]
indicates data missing or illegible when filed

The XRD spectra and electrical response of the as-cold-sintered SBA is similar to previous reports of SBA which has intercalated water or generated carbonates. Prior work has shown that the water and carbonates can be removed with annealing under inert atmospheres. Thus, the as-cold-sintered SBA was subjected to annealing under argon at 900° C. or 1200° C. to investigate the possibility of removing said impurities from the cold sintered samples.

After annealing, the room temperature conductivity of the rises from 3.4*10⁻⁷ S cm⁻¹ (as-cold-sintered) to 1.1*10⁻⁶ S cm⁻¹ (900° C. anneal) and 5.2*10⁻⁵ S cm⁻¹ (1200° C. anneal). The activation energy below 200° C. decreases from an initial value of 0.54 eV to 0.48 eV (900° C. anneal) and 0.38 eV (1200° C. anneal) (see FIGS. 7A and 7B). The conductivity at 300° C. of the 900° C. annealed sample remains close to the as-cold-sintered sample (6.4*10⁻³ S cm⁻¹) while the conductivity of the 1200° C. annealed sample decreases to 3.2*10⁻³ S cm⁻¹. This decrease in conductivity at 300° C. as the annealing temperature is increased is likely due to dedensification during annealing, as suggested by micrographs. These changes impact the conductivity of the SBA through the removal of interfacial phases such as carbonates and hydroxls along with some microstructural evolution.

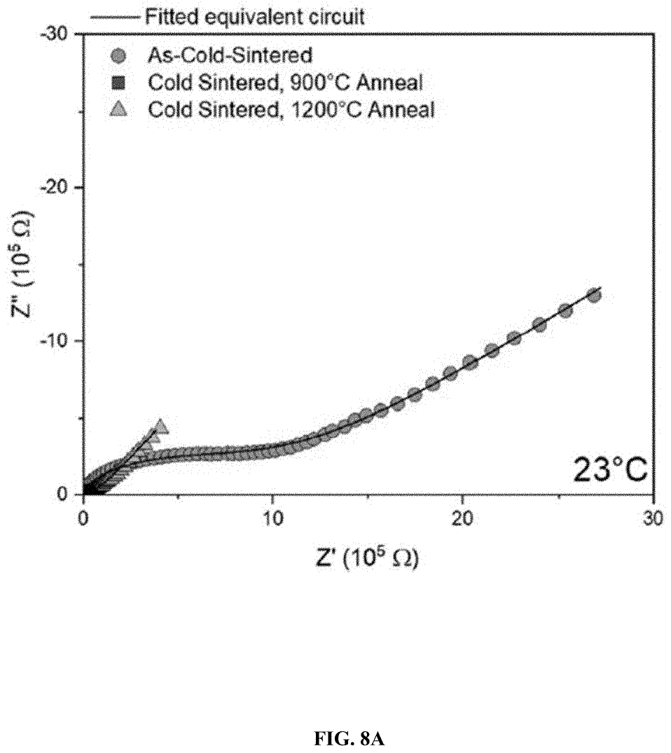

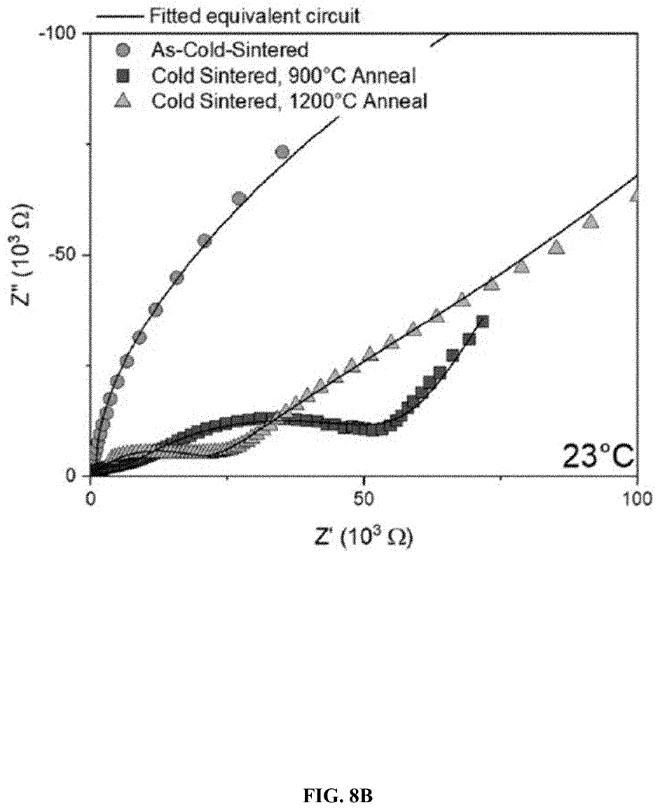

FIG. 8A show room temperature EIS spectra of as-cold-sintered SBA compared to cold sintered SBA annealed at 900° C. and 1200° C. FIG. 8B shows a magnified view highlighting the more conductive annealed samples. The increased conductivity of the annealed samples is also exemplified by the impedance spectra at room temperature. After annealing, the large asymmetric semicircle is replaced by small, suppressed, semicircles at the highest frequencies followed by an electrode polarization.

The impedance spectra of the annealed samples is best fit with two sets of parallel resistor/CPEs in series, suggesting two distinct responses. By noting that the second (lower frequency) semicircle increases in diameter while being held at room temperature, we ascribe the high frequency semicircle to the pure SBA response and the low frequency semicircle to the re-formation of the Na₂CO₃, which was removed during annealing but forms quickly under ambient conditions. In light of this, the impedance measurements of the annealed samples were taken immediately upon removal from the furnace, thereby minimizing the carbonate contribution. The total conductivity remains derived from the extrapolation of the linear electrode response to the intersection of the Z′ axis.

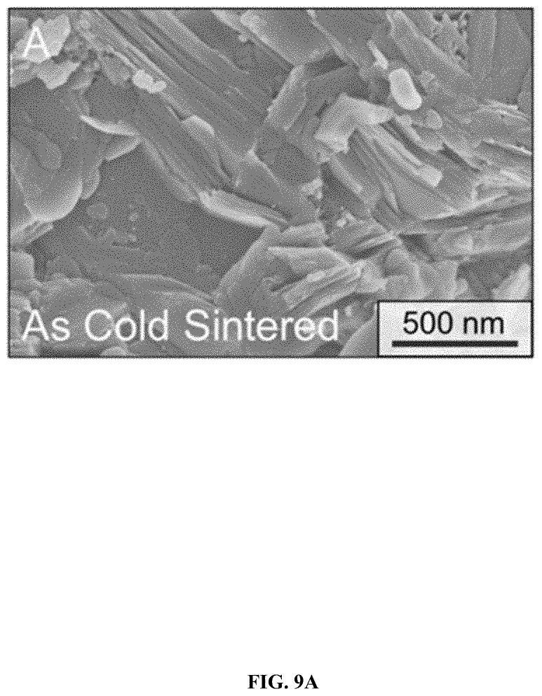

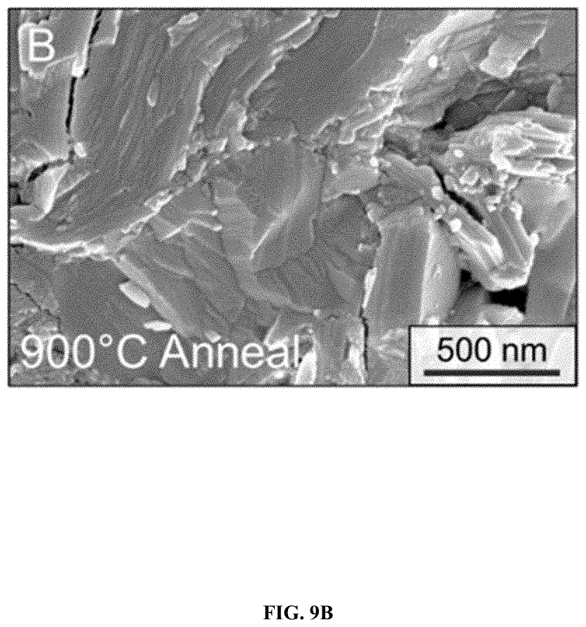

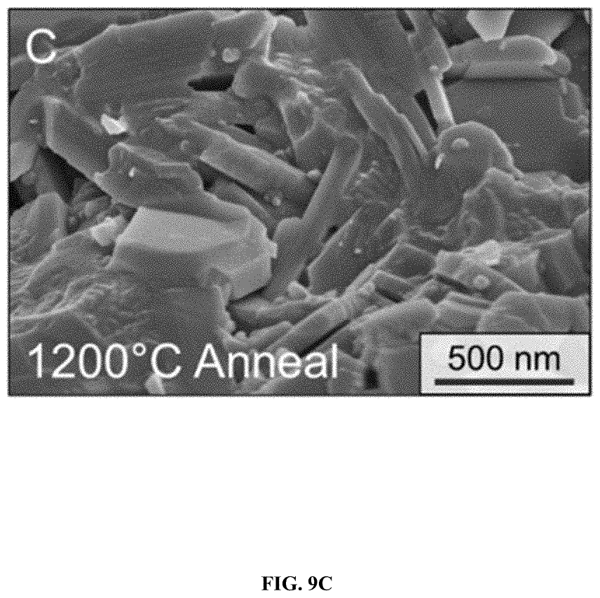

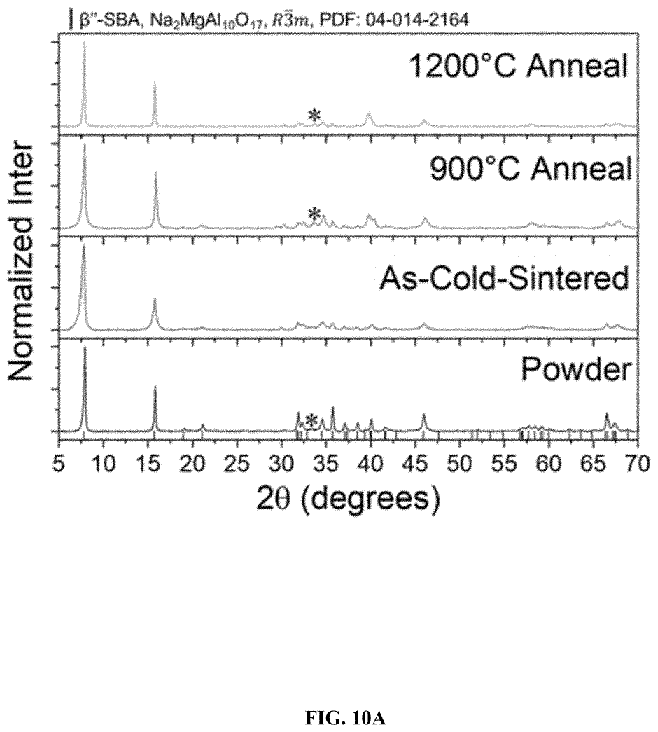

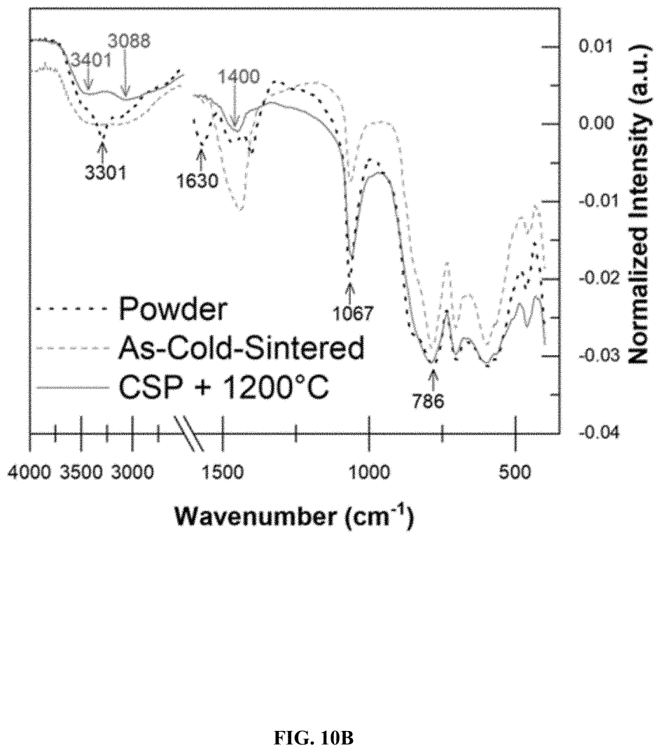

FIGS. 9A, 9B, and 9C show SEM images of the microstructure of an as-cold-sintered SBA sample (FIG. 9A) compared to that of a sample annealed at 900° C. (FIG. 9B), and 1200° C. (FIG. 9C). FIG. 10A shows XRD spectrum for the initial powder, the as-cold-sintered, 900° C., and 1200° C. annealed SBA (β′ is marked with (*)). FIG. 10B shows FTIR spectra for the SBA powder, an as-cold-sintered sample, and a cold sintered sample annealed at 1200° C. (CSP— Cold Sintering Process).

The microstructure of the as-cold-sintered SBA is shown in FIG. 9A, alongside that of samples which had been annealed under argon at 900° C. (see FIG. 9B) and 1200° C. (see FIG. 9C). As the annealing temperature is increased, the SBA grains grow, and it appears that some pores are formed/enlarged. This is especially evident in FIG. 10C where the thickness of the SBA platelet-like grains is increased significantly relative to the powder (see FIG. 5A) and the as-cold-sintered samples (see FIGS. 5B-5C; FIG. 9A). It is also clear that fair amount of enclosed porosity is evolved, which is consistent with some progressively lower densities of the pellets as the annealing temperature is increased; the relative densities are 92.7%, 89.6%, and 83.8% for the as-cold-sintered, 900° C. annealed, and 1200° C. annealed samples respectively (see Table 1). This decrease in relative density as the annealing temperature is raised is also consistent with the slightly lower ionic conductivity at high temperatures noted above.

XRD and FTIR were conducted on the initial powder, the as-cold-sintered samples, and the annealed samples to observe the removal of carbonates/moisture and changes in structure. FIG. 10A illustrates the progressive peak sharpening as the samples are annealed, as well as a shift of the conduction layer peak (ca. 7.9° 2θ) to slightly lower angles, indicating a decrease in the conduction layer height and removal of water from the conduction plane. The annealed samples have (003) Bragg angles closer to that of the powder and small FWHM values which suggests a high degree of crystallinity; the Bragg angles (FWHM) are 7.93° (0.22°), 7.84° (0.43°), and 7.89° (0.17°) for the powder, as-cold-sintered pellet, and 1200° C. annealed samples, respectively.

The expulsion of water and removal of carbonates is further evidenced by comparing the FTIR spectra of the powder, an as-cold-sintered sample, and an annealed sample (see FIG. 10B). IR bands characteristic of carbonates (1400 cm⁻¹), hydrated carbonates (1468 cm⁻¹), and water (1630 cm⁻¹) are present in the the initial powder, which are then replaced by a single IR band at 1440 cm⁻¹ in the cold sintered sample. This 1440 cm⁻¹ band has been assigned to hydrated carbonates which form on SBA surfaces. After annealing, the intensity of the 1440 cm⁻¹ decreases significantly, indicating a removal of a superficial carbonate phase. Similarly, a broad band centered at 3301 cm⁻¹ observed in the initial powder and the as-cold-sintered sample is replaced by two much smaller bands at 3483 cm⁻¹ and 3088 cm⁻¹ which points to a decrease in the amount of hydrogen-bonded hydroxyl groups, similar to what one might expect from the removal of water from the conduction plane of the SBA.

These results collectively point to three factors which contribute to the increase in conductivity upon annealing of cold sintered SBA. First, the amorphous grain boundary regions observed in TEM are recrystallized upon annealing as evidenced by the XRD peak sharpness and SEM images. Second, some grain boundaries in the as-cold-sintered SBA contain carbonates, which is coupled with water intercalation, and these features are removed by annealing, as evidenced by reduction in activation energy for conduction, (003) peak shifts, and FTIR signatures. Third, carbonates readily form at exposed SBA surfaces, as evidenced by the carbonate formation observed on the surface of a polished pellet and the small signature in the FTIR. With respect to the third factor, it is expected that the annealing process produces a clean interface between the SBA pellets and the platinum electrode which is greatly improved relative to the as-cold-sintered pellet surfaces. While conventionally sintered SBA must contend chiefly with the third factor, our results demonstrate the additional factors which must be considered when processing such materials by new low temperature methods.

To summarize, it is shown that the cold sintering process can be applied at 375° C. with an NaOH transient phase to produce remarkably dense microstructures of β″ SBA. The electrical properties at high temperatures are competitive with conventionally fired SBA, but the low temperature conductivity and activation energy deviate from conventionally sintered SBA. The increased resistance at low temperatures appears to originate from the reaction of the SBA with water and carbon in the air. With intermediate temperature annealing, the absorbed water and carbonates are removed, and amorphous grain boundaries are crystallized, resulting in an improvement in low temperature conductivity.

The as-cold-sintered SBA may therefore be attractive for technologies which operate at high temperatures (ca. 300° C.), such as sodium—metal-halide batteries, owing to the conductivity of the as-cold-sintered SBA being competitive with conventionally sintered SBA at these temperatures. Furthermore, the energy savings associated with reducing the sintering temperature from 1600° C. to 375° C. may counterbalance the modest decrease in conductivity between samples sintered by conventional means and by cold sintering, respectively. However, for applications which require high conductivity at lower temperatures, the intermediate temperature annealing process appears to be necessary. While the annealing process improves the properties and aids in the study of the system as a whole, this secondary processing diminishes the amount of energy saved in sintering and opportunities to co-process SBA with very thermally fragile materials.

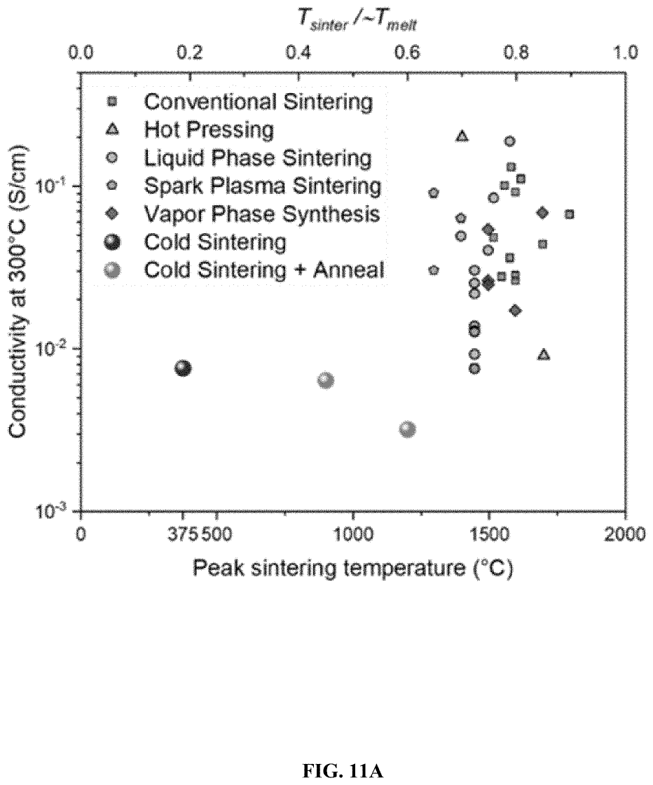

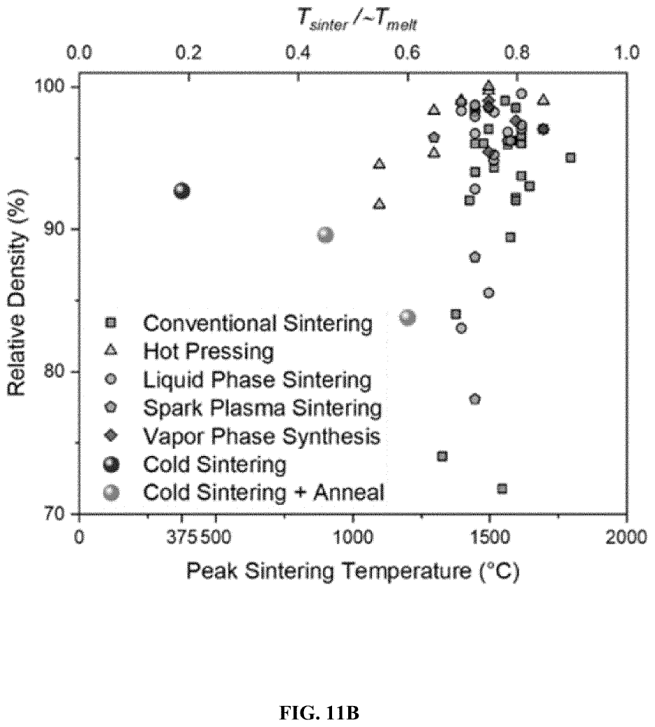

FIGS. 11A and 11B show ionic conductivity at 300° C. (FIG. 11A) and relative density (FIG. 11B) plotted as a function of peak sintering temperature for this work and a representative selection of prior work. Peak sintering temperature is defined as the maximum temperature observed by the samples prior to electrical measurement. A secondary x-axis of normalized sintering temperature (Tₛ/Tₘ) is also provided. To place these results within the context of the greater body of existing literature concerning the property-processing relationship of SBA, FIGS. 11A and 11B show a plot of the ionic conductivity at 300° C. (see FIG. 11A) and relative density (see FIG. 11A) as a function of peak sintering temperature for this work and a large number of previous studies. The comparative data points are taken from 22 individual studies which span nearly 50 years of research. Examples of conventional sintering, hot pressing, liquid phase sintering, and field-assisted sintering all applied to polycrystalline SBA are represented in the set of literature references. Evidently, cold sintering accesses a unique processing window for this refractory solid electrolyte.

The cold sintering process was applied to the β″-Al₂O₃ solid-state electrolyte at 375° C. using pure NaOH as the transient solvent. Coupled with 360 MPa of uniaxial pressure and a dwell time of three hours, a relative density of 92.7% was achieved. The microstructure of the samples is dense and retains the powder grain size (ca. 1 to 5 μm). While the conductivity of the as-cold-sintered samples nears conventional values (7.6*10⁻³ S cm⁻¹), the room temperature conductivity (3.4*10⁻⁷ S cm⁻¹) and activation energy (0.54 eV) lag conventionally sintered SBA. The low temperature electrical properties are traced to a change in conduction layer spacing which can be reversed with an argon annealing step at 900° C. or 1200° C. Consistent with prior work, the room temperature conductivity is increased (reaching 5.2*10⁻⁵ S cm⁻¹) and the activation energy is decreased (reaching 0.38 eV) with annealing, while the conductivity at 300° C. remains about a half of an order of magnitude lower than the conventionally sintered values of about 1*10⁻² S cm⁻¹. The renormalization of the SBA sintering temperature from 80% of Tₘ to 20% of Tₘ presents opportunities for co-processing this historically refractory solid electrolyte with thermally fragile electrodes for next-generation sodium-ion based energy storage technologies.

Some embodiments of the sintering method disclosed herein involve use of a fused hydroxide (NaOH) to increase the reactivity of the solvent-particle interaction while also retaining the increased driving forces for densification characteristic of cold sintering, namely, the transient nature of the solvent and uniaxial pressure applied to an open system. Changes in phase purity, conductivity, and density can be achieved by varying the process temperature, weight fraction hydroxide, and dwell time. The following paragraphs demonstrate results of using fused hydroxide (NaOH) in a cold sintering method for densification of a solid state NASICON sodium-ion electrolyte.

While the following pertains to fused hydroxide (NaOH) in a cold sintering method for densification of a solid state NASICON sodium-ion electrolyte, it should be noted that Sodium β″-Alumina (SBA) and NASICON-structured Na₃Zr₂Si₂PO₁₂ (NZSP) are very different materials, and one would not expect them to behave similarly. Thus, use of the methods and techniques disclosed herein on SBA yielded unexpected results.
1. SBA can be described as having a 2D structure, with alternating layers of refractory Al₂O₃ and weakly bonded layers of mobile sodium ions. NZSP, on the other hand, can be described as having a 3D structure, where a rigid framework of ZrO₆, SiO₄, and PO₄ polyhedra create a number of percolating sodium sites. Thus, the only commonality in structure/chemistry between the two materials is the presence of mobile sodium ions.
2. The sintering process requires the rupture of all bonds in a material, so one would not expect materials with different structures/bonding to sinter under the same conditions.
3. A general rule of thumb is that the conventional sintering temperature is about two-thirds of the melting temperature. The melting temperature of NZSP is approximately 1275° C. whereas the melting temperature of SBA is approximately 2000° C. This is difference is reflected by a large difference in the conventional sintering temperatures of the respective materials and would be expected to be similarly reflected in their respective cold sintering temperatures.
4. NZSP is known to be soluble in molten hydroxides/salts, whereas SBA is not.
5. Previous work has shown that NZSP can be synthesized from the dissolution of precursors into a bath of molten salts. The cold sintering transient solvent, NaOH, can be described as a molten salt. Dissolution is an integral part of cold sintering [80], [81], so it follows that NaOH should be an effective transient solvent for NZSP.
6. Previous work has shown that SBA is stable (i.e., does not dissolve) when immersed into molten salts. SBA is known, however, to exchange cations ions with molten salts.
7. Therefore, it would be expected that NaOH would be an effective cold sintering agent for NZSP while being ineffective in the case of SBA.
8. Aqueous hydroxide solutions (i.e., NaOH and KOH dissolved into H₂O) are effective transient agents in cold sintering of NZSP. Aqueous solutions of NaOH are not effective in promoting any densification of SBA, per our preliminary experiments.
9. The degradation of SBA under exposure of the ambient atmosphere has been widely noted. This degradation includes the exchange of sodium ions with water molecules and the formation of sodium carbonates. Since cold sintering with molten salts can only be carried out under ambient atmosphere, one would expect that the cold sintering process would result in the degradation of the SBA.
10. Preliminary experiments confirmed this. The as-cold-sintered SBA has very low room temperature ionic conductivity, which was traced to sodium carbonate formation and water intercalation. A secondary annealing process was shown to reverse these changes.
11. By contrast, NZSP is known to be stable in air. No secondary annealing process was required to “clean” the as-cold-sintered NZSP. Thus, the initial demonstration of cold sintering NZSP with NaOH did not directly imply, and did not directly translate to, a successful cold sintering of SBA.

A study was conducted on the effects of molten NaOH as a transient solvent for this study. Its melting temperature (312° C.) is attainable in current cold sintering apparatuses, thus enabling a one-step process in which solid NaOH flakes are mixed with Na₃Zr₂Si₂PO₁₂ (NZSP) powder, charged into a die, uniaxially pressed, and heated to T>312° C., resulting in a liquid NaOH transient solvent to drive the cold sintering process. Fused hydroxides, and the broader family of ionic liquids, have been widely employed as the reactive solvents in complex compound growth from the melt with at least one study demonstrating NASICON synthesis from phosphate precursors.

The mechanisms of cold sintering are still under debate, but seem to point to a densification process enabled by a chemical potential gradient generated at the particle-liquid-particle interfaces under the influence of external pressure and where the solvent is allowed to leave the system. In aqueous cold sintering, the solvent is evaporated, while here the NaOH solvent is extruded. Thus, while this process and aqueous sintering processes share many similarities, they may differ fundamentally in their driving force(s). To acknowledge these potential differences and differentiate this work from aqueous processes, this process is referred to as a fused hydroxide cold sintering process (FH-CSP). FH-CSP conducted under 400° C. yields conductivities and relative densities comparable to known sintering techniques at 800-1000° C. FH-CSP has also been recently applied to the dielectric BaTiO₃ with similar success.

The powders used in this study were synthesized via a solution-assisted solid-state reaction route (SaSSR) rather than a typical solid-state reaction (SSR). Preliminary experiments showed that the reduced particle size and minimal ZrO2 secondary phase characteristic of SaSSR powders (versus SSR powders) were beneficial to final densities and conductivities. SaSSR powder synthesis has been described at length in previous publications by Naqash and Ma et al. Here, NaNO3 (Sigma-Aldrich, >99.0%), ZrO2 (Alfa Aesar, 99.7%, 325-mesh), tetraethylorthosilicate (TEOS, Sigma-Aldrich, 99.0%), and NH4H2PO4 (Alfa Aesar, 98.0%) were used as precursors in the stoichiometric ratio of 3:2:2:1. The precursors were dissolved in the aqueous solution sequentially and stirred at 50° C. overnight. The water was then slowly driven off to induce gelation. The drying of the gel was completed in a 120° C. oven, giving an agglomerated white powder. The agglomerates were broken up in a pestle and then calcined at 600° C. (3 h) in air under oxygen flow to pyrolyze the carbonaceous, NOx, CO2, and H₂O components of the amorphous mixture. This raw powder was further calcined in air (without oxygen flow) at 1000° C. (12 h) to obtain the desired NASICON stoichiometry. The calcination temperature and dwell time were increased in relation to the referenced procedure to increase the final grain size of the powder. Further, the reported 800° C. calcine was found to not generate completely phase-pure NASICON in our laboratory. The calcined powder was milled in ethanol in a 70:30 w/w ratio of 5:3 mm yttria-stabilized zirconia (YSZ) milling media for 24 h and dried at 80° C. This powder was then kept in a vacuum oven at 75° C. when not in use to reduce the absorption of moisture. Dynamic light scattering (DLS, PANalytical Mastersizer) of the powder dispersed in ethanol was used to measure the particle size distribution, yielding D90=8.8 μm and D50=2.2 μm. The sodium hydroxide used in this study was obtained from Sigma-Aldrich as solid flakes (NaOH, 97%). The NaOH was used without further purification. When not in use, the flakes were stored under vacuum in the presence of a desiccant. It should be noted that previous works have found up to 15 w/w of absorbed H₂O in commercial NaOH, which may significantly alter its thermal and chemical properties.

A prescribed mass ratio of the NZSP and NaOH (ranging from 5 to 15 w/w NaOH/NZSP) was measured and combined in a mortar and pestle. The mixture was sheared vigorously so that the NaOH flakes were distributed relatively homogenously in the NZSP powder. This step was carried out as quickly as possible (<5 min) to reduce the exposure of the NaOH to the moisture and carbon in air. The mixture was loaded in a stainless-steel die with a 13 mm inner radius (Across International), which had been lightly lubricated with oleic acid. Disposable 0.1 mm nickel foils (Alfa Aesar, 99.95%) were placed at the interface between the powder and the die punches to reduce potential contamination from die corrosion. The apparatus was then fitted with a band heater and loaded into a uniaxial press equipped with heated platens. The powder was then compacted at 350 MPa for 5 min at room temperature to allow for particle rearrangement to occur. The temperature and pressure were then quickly increased to cold sintering conditions, with an approximate heating rate of 20° C./min. Die temperatures ranging from 350 to 400° C. were used to assess the FH-CSP thermal dependence. The heated platens of the uniaxial press were activated (maximum temperature ca. 250° C.) to reduce thermal gradients in the system. After the specified sintering time had elapsed, the heating elements were switched off and a small (ca. 15 cm) fan was directed at the die, cooling the setup to room temperature and gradually removing the pressure over the course of approximately 30 min. The sintered sample was then removed and dried at 120° C. for 12 h and then kept in a 75° C. vacuum oven for characterization.

Some samples of the same powder were densified by conventional high-temperature means for comparison. The powder was pressed in a 13 mm die with 350 MPa and then cold isostatically pressed at 200 MPa. The green compacts were then fired in a furnace at 1200° C. for 6 h in air without submersion in mother powder. The density of the sintered pellets was measured using the Archimedes method, using ethanol as a reference solvent. The X-ray diffraction (XRD) patterns of polished sample surfaces were measured by a PANalytical Empyrean diffractometer in Bragg-Brentano configuration with operating parameters of 45 kV and 40 mA. A 2Θ range of 10-60 was scanned with a step size of 0.026 with Cu Kα radiation. The microstructure of the samples was characterized by scanning electron microscopy (SEM, FEI Nova NanoSEM 630) on fractured surfaces coated with ˜5 nm of iridium and an accelerating voltage of 15 kV. The microstructural elemental distribution was observed using electron dispersive spectroscopy (EDS) also at 15 kV.

Further microstructural characterizations were performed by scanning transmission electron microscopy (STEM). The electron transparent samples were milled and extracted from the surface of a pellet with a focused ion beam (FEI Helios 660) using Ga+ ions at 30 kV. Scanning transmission electron microscopy (FEI Titan3 G2) was conducted at 200 kV with a bright-field detector. EDS mapping was conducted with a SuperX EDS system in STEM mode. The relative stoichiometry of the initial powder was evaluated using electron probe microanalysis (EPMA, Cameca SX-5). An accelerating voltage of 20 kV, a beam current of 10 nA, and a spot size of 10 μm were used. Synthetic and natural oxides for sodium, zirconium, phosphorus, and silicon were used as calibration standards. The composition was then evaluated assuming the Na1+xZr2SixP3-xO12 compositional model, where x was evaluated from the relative atomic abundances of Si and P.

Electrochemical impedance spectroscopy (EIS) was performed to measure the ionic conductivity of the dense specimen. The surfaces of the samples were polished by hand up to 1200 grit and a mirror-like finish was observed. The samples were then coated with circular gold electrodes using a Quorum Technologies EMS 150R-S sputter coater and a gold target (Kurt J. Lesker). The electrodes were approximately 80 nm in thickness and the areas were approximately 0.1 cm²; precise measurements of the electrode areas were obtained using the ImageJ image processing software. Prior to measurement, the coated samples were dried in a vacuum oven at 75° C. for 24 h to remove any moisture. The EIS spectrum was collected with an impedance analyzer (Modulab XM MTS) over a frequency range of 1 MHz to 0.05 Hz with an A.C. amplitude of 0.5 V. EIS measurements as a function of temperature were carried out in air inside a Delta 9023 oven with a nominal thermal soak time of 15 min. The thickness of the samples ranged from 0.3 to 0.9 mm. EIS spectra were analyzed using the ZView program (Scribner Associates).

The results showed that use of a fused hydroxide (NaOH at T>312° C.) increased the reactivity of the transient solvent. The fused hydroxide-modified CSP process (FH-CSP) was shown to be effective in densifying the sodium-ion solid-state electrolyte Na3Zr2Si2PO12 at ca. 375° C. in 3 h with 5-12.5 w/w NaOH. The room-temperature grain boundary conductivities are above 10-4 S/cm, only 1 order of magnitude lower than the highest conductivities demonstrated for such systems (10-3 S/cm). The relative densities of the samples are consistently above 90%, with the microstructure showing complete grain boundary dihedral angle equilibration. Below die temperatures of 375° C., a secondary phase structurally similar to hydronium-substituted NASICON is observed. Above 375° C., the degree of crystallinity in the system decreases and ionic conductivities are low (>10-5 S/cm). With careful processing, minimal NaOH is retained in the microstructure and excellent properties and microstructure are observed. Slight deviations in the amount of NaOH or other FH-CSP processing parameters result in secondary precipitates in the microstructure and abnormalities in impedance response. Direct comparisons of ambient grain boundary conductivities obtained by FH-CSP with those obtained by recent applications of aqueous cold sintering, field-assisted techniques, liquid-phase sintering, and conventional sintering show that the present work lies in an unexplored and promising region of the conductivity versus sintering/annealing temperature processing space.

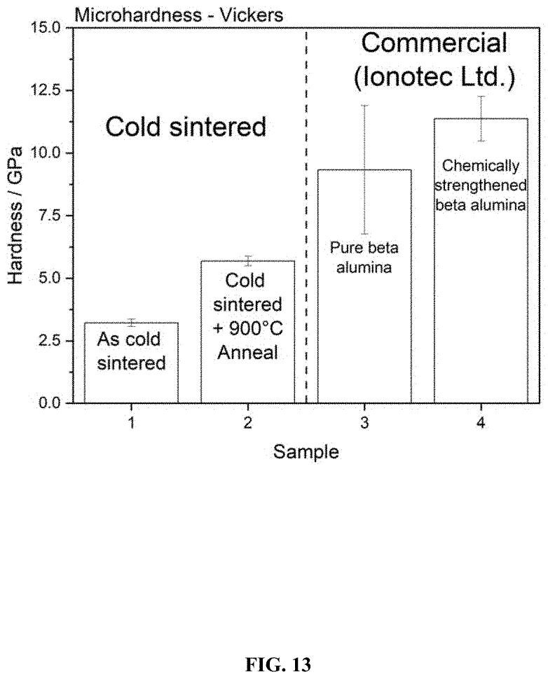

FIG. 13 shows a microhardness comparison chart between embodiments of the as-cold sintered alumina and other alumina products. The hardness of the as-cold sintered alumina is less than those of the other alumina products, but the hardness is comparable and produced as much lower sintering temperatures.

As can be appreciated from the disclosure, embodiments of the method can be used to create composites of beta alumina and other electrolytes. The properties of such composite would be enhanced relative to the pure materials. For example, cold sintering techniques disclosed herein can be applied to NASICON Na₃Zr₂Si₂PO₁₂ (NZSP) solid electrolyte using NaOH at 375° C., 350 MPa, 3 hours). Another example can involve cold sintering (using the cold sintering techniques disclosed herein—e.g., 10 w/w NaOH, 375° C., 350 MPa, 3 hours) of composite cathodes comprising NZSP solid electrolyte, Na₃V₂(PO₄)₃, and carbon using nearly identical cold sintering parameters. Benefits can include:
Increased conductivity at room temperature, relative to pure beta alumina;
Increased stability against CO₂, relative to beta alumina;
In the case of a beta alumina—NZSP composite, increased stability against molten Na and high temperature operation (relative to NZSP).

The following references are incorporated herein by reference in their entirety.
[1] K. B. Hueso, M. Armand, and T. Rojo, “High temperature sodium batteries: status, challenges and future trends,” Energy Environ. Sci., vol. 6, pp. 734-749, 2013.
[2] O. Bohnke, S. Ronchetti, and D. Mazza, “Conductivity measurements on nasicon and nasicon-modified materials,” Solid State Ionics, vol. 122, no. 1-4, pp. 127-136, 1999.
[3] R. O. Ansell, “The chemical and electrochemical stability of beta-alumina,” J. Mater. Sci., vol. 21, pp. 365-379, 1986.
[4] M. Bettman and C. R. Peters, “The crystal structure of Na₂O.MgO.5Al₂O₃ with reference to Na₂O.5Al₂O₃ and other isotypal compounds,” J. Phys. Chem., vol. 73, no. 6, pp. 1774-1780, 1969.
[5] C. R. Peters, M. Bettman, J. W. Moore, and M. D. Glick, “Refinement of the structure of sodium β-alumina,” Acta Crystallogr. Sect. B Struct. Crystallogr. Cryst. Chem., vol. 27, no. 9, pp. 1826-1834, 1971.
[6] M. C. Bay et al, “Impact of liquid phase formation on microstructure and conductivity of Li-stabilized Na-β″-alumina ceramics,” ACS Appl. Energy Mater., vol. 2, no. 1, pp. 687-693, 2019.
[7] S. N. Heavens, “Structural transformation during sintering and annealing of beta alumina,” J. Mater. Sci., vol. 19, no. 7, pp. 2223-2232, 1984.
[8] D.-D. Lee, J.-H. Kim, and Yoon-Ho Kim, “The relative stability of beta and beta”-phases in Na₂0-Al₂O₃ beta alumina,” J. Mater. Sci., vol. 25, pp. 2897-2900, 1990.
[9] J. D. Hodge, “Kinetics of the β″-to-β Transformation in the System Na₂O—Al₂O₃,” J. Am. Ceram. Soc., vol. 66, no. 3, pp. 166-169, 1983.
[10] M. C. Bay et al., “Impact of sintering conditions and zirconia addition on flexural strength and ion conductivity of Na-β″-alumina ceramics,” Mater. Today Commun., vol. 23, no. January, p. 101118, 2020.
[11] M. Balaish, J. C. Gonzalez-rosillo, K. J. Kim, Y. Zhu, Z. D. Hood, and J. L. M. Rupp, “Processing thin but robust electrlytes for solid-state batteries,” Nat. Energy, 2021.
[12] T. Famprikis, P. Canepa, J. A. Dawson, M. S. Islam, and C. Masquelier, “Fundamentals of inorganic solid-state electrolytes for batteries,” Nat. Mater., 2019.
[13] R. C. De Vries and W. L. Roth, “Critical Evaluation of the Literature Data on Beta Alumina and Related Phases: I, Phase Equilibria and Characterization of Beta Alumina Phases,” J. Am. Ceram. Soc., vol. 52, no. 7, pp. 364-369, 1969.
[14] J.-H. Park, K.-H. Kim, and S.-K. Lim, “Influence of stabilizers on Na-β″-Al₂O₃ phase formation in Li₂O(MgO)—Na₂O—Al₂O₃ ternary systems,” J. Mater. Sci., vol. 33, pp. 5671-5765, 1998.
[15] T. D. Sparks and L. Ghadbeigi, “Anisotropic properties of Na-β″-alumina+YSZ composite synthesized by vapor phase method,” J. Mater. Res., vol. 33, no. 1, pp. 81-89, 2018.
[16] D. H. Lee, S. T. Lee, J. S. Kim, and S. K. Lim, “Analysis of properties of partially stabilized zirconia-doped Na+-beta-alumina prepared by calcining-cum-sintering process,” Mater. Res. Bull., vol. 96, pp. 143-148, 2017.
[17] X. Wei, Y. Cao, L. Lu, H. Yang, and X. Shen, “Synthesis and characterization of titanium doped sodium beta”-alumina,” J. Alloys Compd., vol. 509, no. 21, pp. 6222-6226, 2011.
[18] H. A. Moghadam and M. H. Paydar, “Low-temperature sintering of sodium beta alumina ceramics using nanosized SnO₂ sintering aid,” Process. Appl. Ceram., vol. 14, no. 1, pp. 56-62, 2020.
[19] C. Chen, H. Katsui, and T. Goto, “Synthesis of sodium beta alumina films by heat treatment of sodium aluminum oxides,” J. Wuhan Univ. Technol. Mater. Sci. Ed., vol. 31, no. 1, pp. 6-10, 2016.
[20] A. V. Virkar, G. J. Tennenhouse, and R. S. Gordon, “Hot Pressing of Li₂O-Stabilized Beta”-Alumina,” J. Am. Ceram. Soc., vol. 57, no. 11, p. 508, 1974.
[21] A. Kishimoto, K. Shimokawa, and S. J. Jung, “Effect of sodium content on the mechanical and electrical properties of preferentially oriented Naβ-alumina ceramics,” J. Mater. Sci. Lett., vol. 22, no. 15, pp. 1083-1085, 2003.
[22] P. Vincenzini, A. Bellosi, and G. N. Babini, “The Influence of Powder Characteristics on the Vacuum Hot Pressing of Sodium Beta-Aluminas,” Mater. Chem., vol. 3, pp. 129-156, 1978.
[23] K. Li, Y. Yang, X. Zhang, and S. Liang, “Highly oriented β″-alumina ceramics with excellent ionic conductivity and mechanical performance obtained by spark plasma sintering technique,” J. Mater. Sci., vol. 55, no. 20, pp. 8435-8443, 2020.
[24] S. Liang, Y. Yang, K. Li, and X. Zhang, “A study on the preparation of oriented β″-alumina ceramics using rod/flake-like boehmite as precursors and their properties,” J. Eur. Ceram. Soc., vol. 40, no. 12, pp. 4047-4055, 2020.
[25] K. Koganei, T. Oyama, M. Inada, N. Enomoto, and K. Hayashi, “C-axis oriented β″-alumina ceramics with anisotropic ionic conductivity prepared by spark plasma sintering,” Solid State Ionics, vol. 267, pp. 22-26, 2014.
[26] R. Subasri, T. Mathews, O. M. Sreedharan, and V. S. Raghunathan, “Microwave processing of sodium beta alumina,” Solid State Ionics, vol. 158, no. 1-2, pp. 199-204, 2003.
[27] C. Mortalo et al., “Microwave assisted sintering of Na-β″-Al₂O₃ in single mode cavities: Insights in the use of 2450 MHz frequency and preliminary experiments at 5800 MHz,” Ceram. Int., vol. 46, no. 18, pp. 28767-28777, 2020.
[28] J. Guo et al., “Cold Sintering: A Paradigm Shift for Processing and Integration of Ceramics,” Angew. Chemie-Int. Ed., vol. 55, no. 38, pp. 11457-11461, 2016.
[29] M. Y. Sengul, C. A. Randall, and A. C. T. Van Duin, “ReaxFF Molecular Dynamics Study on the Influence of Temperature on Adsorption, Desorption, and Decomposition at the Acetic Acid/Water/ZnO(1010) Interface Enabling Cold Sintering,” ACS Appl. Mater. Interfaces, vol. 10, no. 43, pp. 37717-37724, 2018.
[30] S. Lowum, R. Floyd, and J.-P. Maria, “Hydroflux-assisted densification: applying flux crystal growth techniques to cold sintering,” J. Mater. Sci., 2020.
[31] S. Grasso et al., “A review of cold sintering processes,” Adv. Appl. Ceram., vol. 0, no. 0, pp. 1-29, 2020.
[32] A. Ndayishimiye et al., “Comparing hydrothermal sintering and cold sintering process: Mechanisms, microstructure, kinetics and chemistry,” J. Eur. Ceram. Soc., vol. 40, no. 4, pp. 1312-1324, 2020.
[33] S. Uhlenbruck et al., “Cathode-electrolyte material interactions during manufacturing of inorganic solid-state lithium batteries,” J. Electroceramics, vol. 38, no. 2-4, pp. 197-206, 2017.
[34] Z. Grady, J. Seo, K. Tsuji, and A. Ndayishimiye, “Cold Sintering for High-Temperature Electrochemical Applications,” Electrochem. Interface, pp. 23-25, 2020.
[35] J.-H. Seo et al., “Cold sintering, enabling a route to co-sinter an all-solid-state lithium-ion battery,” Jpn. J. Appl. Phys., 2021.
[36] Z. M. Grady, K. Tsuji, A. Ndayishimiye, J. Hwan-Seo, and C. A. Randall, “Densification of a Solid-State NASICON Sodium-Ion Electrolyte Below 400° C. by Cold Sintering With a Fused Hydroxide Solvent,” ACS Appl. Energy Mater., vol. 3, no. 5, pp. 4356-4366, 2020.
[37] K. Tsuji et al., “Single Step Densification of High Permittivity BaTiO₃ at 300° C.,” J. Eur. Ceram. Soc., 2019.
[38] S. Lowum, J. Maria, and R. D. F. Jr, “Cold sintering of magnetic BaFe₁₂O₁₉ and other ferrites at 300° C.,” J. Mater. Sci., 2021.
[39] J.-H. Seo et al., “Broad temperature dependence, high conductivity, and structure-property relations of cold sintering of LLZO-based composite electrolytes,” J. Eur. Ceram. Soc., vol. 40, no. June, pp. 6241-6248, 2020.
[40] W. Lee et al., “Ceramic-Salt Composite Electrolytes from Cold Sintering,” Adv. Funct. Mater., vol. 1807872, p. 1807872, 2019.
[41] T. Zaengle et al., “Single step densification of nanocrystalline CeO₂ by the cold sintering process,” J. Am. Ceram. Soc., vol. 1, no. 814, pp. 0-3, 2020.
[42] J. P. Gratier, D. K. Dysthe, and F. Renard, The Role of Pressure Solution Creep in the Ductility of the Earth's Upper Crust, vol. 54. Elsevier Inc., 2013.
[43] X. Zhang, C. J. Spiers, and C. J. Peach, “Compaction creep of wet granular calcite by pressure solution at 28° C. to 150° C.,” J. Geophys. Res., vol. 115, no. B9, p. B09217, September 2010.
[44] S. Bell, T. Steinberg, and G. Will, “Corrosion mechanisms in molten salt thermal energy storage for concentrating solar power,” Renew. Sustain. Energy Rev., vol. 114, no. November 2018, p. 109328, 2019.
[45] S. N. Heavens, “Surface layers in polycrystalline sodium beta-alumina,” J. Mater. Sci., vol. 17, no. 4, pp. 965-969, 1982.
[46] B. Dunn, “Effect of Air Exposure on the Resistivity of Sodium Beta and Beta” Aluminas,” J. Am. Ceram. Soc., vol. 64, no. 3, pp. 125-128, 1981.
[47] D. Reed et al., “Wetting of sodium on β″-Al₂O₃/YSZ composites for low temperature planar sodium-metal halide batteries,” J. Power Sources, vol. 227, pp. 94-100, 2013.
[48] N. J. Dudney, J. B. Bates, and J. C. Wang, “Hydration of lithium β-alumina,” J. Chem. Phys., vol. 77, no. 10, pp. 4857-4869, 1982.
[49] B. J. T. S. Irvine, D. C. Sinclair, and A. R. West, “Electroceramics Characterisation by impedance sepctroscopy,” Adv. Mater., vol. 2, no. 3, pp. 132-138, 1990.
[50] A. P. Vadhva et al., “Electrochemical Impedance Spectroscopy for All-Solid-State Batteries: Theory, Methods and Future Outlook,” 2020.
[51] J. W. Fergus, “Ion transport in sodium ion conducting solid electrolytes,” Solid State Ionics, vol. 227, pp. 102-112, 2012.
[52] E. Lilley and J. E. Strutt, “Bulk and Grain Boundary Ionic Conductivity in Polycrystalline β″-Alumina,” Phys. Status Solidi, vol. 54, no. 2, pp. 639-650, 1979.
[53] C. Zhu, Y. Hong, and P. Huang, “Synthesis and characterization of NiO doped beta-Al₂O₃ solid electrolyte,” J. Alloys Compd., vol. 688, pp. 746-751, 2016.
[54] J. H. Kim et al., “Electrical characterization of polycrystalline sodium β″-alumina: Revisited and resolved,” Solid State Ionics, vol. 264, pp. 22-35, 2014.
[55] M. Nagai, T. Kushida, and T. Nishino, “Effect of water vapor on the conductivity of porous Na β/β″-Al₂O₃ ceramics,” Solid State Ionics, vol. 40-41, no. PART 1, pp. 107-110, 1990.
[56] K. Buijs and C. J. H. Schutte, “An infra-red study of the hydrates of sodium carbonate,” Spectrochim. Acta, vol. 17, no. 9-10, pp. 917-920, 1961.
[57] A. Vázquez, T. López, R. Gómez, Bokhimi, A. Morales, and O. Novaro, “X-Ray Diffraction, FTIR, and NMR Characterization of Sol-Gel Alumina Doped with Lanthanum and Cerium,” J. Solid State Chem., vol. 128, no. 2, pp. 161-168, 1997.
[58] J. B. Bates, D. Dohy, and R. L. Anderson, “Reaction of polycrystalline Na β″-alumina with CO₂ and H₂O and the formation of hydroxyl groups,” J. Mater. Sci., vol. 20, no. 9, pp. 3219-3229, 1985.
[59] Y. Sheng, P. Sarkar, and P. S. Nicholson, “The mechanical and electrical properties of ZrO₂—Na β″-Al₂O₃ composites,” J. Mater. Sci., vol. 23, no. 3, pp. 958-967, 1988.
[60] S. T. Lee, D. H. Lee, S. M. Lee, S. S. Han, S. H. Lee, and S. K. Lim, “Effects of calcium impurity on phase relationship, ionic conductivity and microstructure of Na⁺β/β″-alumina solid electrolyte,” Bull. Mater. Sci., vol. 39, no. 3, pp. 729-735, 2016.
[61] S. T. Lee, D. H. Lee, J. S. Kim, and S. K. Lim, “Influence of Fe and Ti addition on properties of Na⁺-β/β″-alumina solid electrolytes,” Met. Mater. Int., vol. 23, no. 2, pp. 246-253, 2017.
[62] S. J. Shan, L. P. Yang, X. M. Liu, X. L. Wei, H. Yang, and X. D. Shen, “Preparation and characterization of TiO₂ doped and MgO stabilized Na-β″-Al₂O₃ electrolyte via a citrate sol-gel method,” J. Alloys Compd., vol. 563, pp. 176-179, 2013.
[63] A. Mali and A. Petric, “Synthesis of sodium β′-alumina powder by sol-gel combustion,” J. Eur. Ceram. Soc., vol. 32, no. 6, pp. 1229-1234, 2012.
[64] A. C. Sutorik, S. S. Neo, D. R. Treadwell, and R. M. Laine, “Synthesis of Ultrafine Beta-Alumina Powders via Flame Spray Pyrolysis of Polymeric Precursors,” J. Am. Ceram. Soc., vol. 81, no. 6, pp. 1477-1486, 1998.
[65] A. Imai and M. Harata, “Ionic conduction of impurity-doped β-alumina ceramics,” Jpn. J. Appl. Phys., vol. 11, no. 2, pp. 180-185, 1972.
[66] T. J. Whalen, G. J. Tennenhouse, and C. Meyer, “Relation of Properties to Microstructure in a B”-Alumina Ceramic,” J. Am. Ceram. Soc., vol. 57, pp. 497-498, 1974.
[67] H. Li et al., “Performance of Nano-3YSZ toughened β″-Alumina solid electrolyte prepared by EDTA-Zr(IV)/Y(III) complex as surface modifier,” J. Alloys Compd., vol. 817, p. 152717, 2020.
[68] X. Lu, G. Li, J. Y. Kim, K. D. Meinhardt, and V. L. Sprenkle, “Enhanced sintering of β″-Al₂O₃/YSZ with the sintering aids of TiO₂ and MnO₂,” J. Power Sources, vol. 295, pp. 167-174, 2015.
[69] L. B. Caliman, R. Bouchet, D. Gouvea, P. Soudant, and M. C. Steil, “Flash sintering of ionic conductors: The need of a reversible electrochemical reaction,” J. Eur. Ceram. Soc., vol. 36, pp. 1253-1260, 2016.
[70] C. Zhang, L. Zhang, P. Zheng, and X. Zhang, “Synthesis of magnesium-beta-alumina composite electrolytes via a vapour phase method,” Ceram. Int., vol. 46, no. 8, pp. 12232-12237, 2020.
[71] S. Barison, S. Fasolin, C. Mortalo, S. Boldrini, and M. Fabrizio, “Effect of precursors on β-alumina electrolyte preparation,” J. Eur. Ceram. Soc., vol. 35, no. 7, pp. 2099-2107, 2015.
[72] A. Hooper, “A study of the electrical properties of single-crystal and polycrystalline β-alumina using complex plane analysis,” J. Phys. D. Appl. Phys., vol. 10, no. 11, pp. 1487-1496, 1977.
[73] B. Wang and A. N. Cormack, “Molecular dynamics simulations of Mg-doped beta”-alumina with potential models fitted for accurate structural response to thermal vibrations,” Solid State Ionics, vol. 263, pp. 9-14, 2014.
[74] M. Alden, J. O. Thomas, and P. Davies, “The Effect of Quenching on The Na+ Ion Distribution in Na+ Beta”-Alumina,” Solid State Ionics, vol. 18-19, pp. 694-698, 1986.
[75] P. h. Boilot, J. P.; Collin, G; Colomban, “Crystal Structure of True NASICON: Na₃Zr₂Si₂PO₁₂,” Mater. Res. Bull., vol. 22, no. c, pp. 669-676, 1987.
[76] R. S. Gordon, G. R. Miller, B. J. McEntire, E. D. Beck, and J. R. Rasmussen, “Fabrication and characterization of NASICON Electrolytes,” Solid State Ionics, vol. 4, no. C, pp. 243-248, 1981.
[77] J. T. Kummer, “B-ALUMINA ELECTROLYTES,” Prog. Solid State Chem., vol. 7, no. 141, 1972.
[78] N. Strutynska et al., “Phase formation in molten system (Na/K)₂O—TiO₂—P₂O₅. Crystal structures of NASICON and langbeinite-related phosphates (K/Na)₁₊ₓTi₂(PO₄)₃ (x=0 and 0.357),” Cryst. Res. Technol., vol. 51, no. 10, pp. 627-633, October 2016.
[79] F. d'Yvoire, M. Pintard-Scrépel, E. Bretey, and M. de la Rochère, “Phase transitions and ionic conduction in 3D skeleton phosphates A₃M₂(PO₄)₃: A=Li, Na, Ag, K; M=Cr, Fe,” Solid State Ionics, vol. 9-10, no. PART 2, pp. 851-857, 1983.
[80] A. Ndayishimiye et al., “Comparing hydrothermal sintering and cold sintering process: Mechanisms, microstructure, kinetics and chemistry,” J. Eur. Ceram. Soc., vol. 40, no. 4, pp. 1312-1324, 2020.
[81] A. Ndayishimiye et al., “Roadmap for densification in cold sintering: Chemical Pathways,” J. Mol. Liq., p. 112490, 2020.
[82] Yung-Fang Yu Yao and J. T. Kummer, “Ion exchange properties of and rates of ionic diffusion in beta-alumina,” J. Inorg. Nucl. Chem., vol. 29, no. 9, 1967.
[83] J. G. Pereira da Silva et al., “Sintering of a sodium-based NASICON electrolyte: A comparative study between cold, field assisted and conventional sintering methods,” J. Eur. Ceram. Soc., vol. 39, no. 8, pp. 2697-2702, 2019.
[84] B. C. Larson, J. B. Bates, N. J. Dudney, and J. F. Barhorst, “Effects of Hydration on Conduction Ion Correlations in Na Beta”-Alumina,” Solid State Ionics, vol. 5, pp. 237-240, 1981.
[85] T. Kaneda, J. B. Bates, and J. C. Wang, “Effect of H₂O on the Ionic Conductivity of Sodium Beta-Alumina,” Mat. Res. Bull, vol. 36, pp. 1053-1056, 1979.
[86] J. B. Bates, D. Dohy, and R. L. Anderson, “Reaction of polycrystalline Na β″-alumina with CO₂ and H₂O and the formation of hydroxyl groups,” J. Mater. Sci., vol. 20, no. 9, pp. 3219-3229, 1985.
[87] L. C. De Jonghe, Grain boundaries and ionic conduction in sodium beta alumina, J. Mater. Sci., 1979, 14(1), 33-48.
[88] T. Ibn-Mohammed, et al., Decarbonising ceramic manufacturing: A techno-economic analysis of energy efficient sintering technologies in the functional materials sector, J. Eur. Ceram. Soc., 2019, 39(16), 5213-5235.
[89] N. Bonanos, B. C. Steele and E. P. Butler, Applications of Impedance Spectroscopy, in Impedance Spectroscopy: Theory, Experiment, and Applications, ed. E. Barsoukov and J. R. Macdonald, John Wiley & Sons, Ltd, Hoboken, N.J., USA, 2nd edn, 2005, pp. 205-264.
[90] S. Havriliak and S. Negami, A complex plane representation of dielectric and mechanical relaxation processes in some polymers, Polymer, 1967, 8, 161-210.
[91] C. Grosse, A program for the fitting of Debye, Cole-Cole, Cole-Davidson, and Havriliak-Negami dispersions to dielectric data, J. Colloid Interface Sci., 2014, 419, 102-106.
[92] C. Léon, M. Lucía and J. Santamaría, Correlated ion hopping in single-crystal yttria-stabilized zirconia, Phys. Rev. B: Condens. Matter Mater. Phys., 1997, 55(2), 882-887.
[93] B. Wang and A. N. Cormack, Molecular dynamics simulations of Mg-doped beta-alumina with potential models fitted for accurate structural response to thermal vibrations, Solid State Ionics, 2014, 263, 9-14.
[94] M. Alden, J. O. Thomas and P. Davies, The Effect of Quenching on The Na+ Ion Distribution in Na+ Beta-Alumina, Solid State Ionics, 1986, 18-19, 694-698.
[95] S. Barison, S. Fasolin, C. Mortalò, S. Boldrini and M. Fabrizio, Effect of precursors on b-alumina electrolyte preparation, J. Eur. Ceram. Soc., 2015, 35(7), 2099-2107.
[96] Y. Sheng, P. Sarkar and P. S. Nicholson, The mechanical and electrical properties of ZrO2-Na b00-Al2O3 composites, J. Mater. Sci., 1988, 23(3), 958-967.
[97] S. T. Lee, D. H. Lee, S. M. Lee, S. S. Han, S. H. Lee and S. K. Lim, Effects of calcium impurity on phase relationship, ionic conductivity and microstructure of Na+-b/b-alumina solid electrolyte, Bull. Mater. Sci., 2016, 39(3), 729-735.
[98] S. T. Lee, D. H. Lee, J. S. Kim and S. K. Lim, Influence of Fe and Ti addition on properties of Na+-b/b-alumina solid electrolytes, Met. Mater. Int., 2017, 23(2), 246-253.
[99] M. Demartin, C. H′erard, C. Carry and J. Lemaître, Dedensification and anomalous grain growth during sintering of undoped barium titanate, J. Am. Ceram. Soc., 1997, 80(5), 1079-1084.
P. Duran, J. Tartaj and C. Moure, Sintering behaviour and microstructural evolution of agglomerated spherical particles of high-purity barium titanate, Ceram. Int., 2003, 29(4), 419-425.
C. Hérard, A. Faivre and J. Lemaître, Surface decontamination treatments of undoped BaTiO3-part I: Powder and green body properties, J. Eur. Ceram. Soc., 1995, 15(2), 135-143.

It should be understood that the disclosure of a range of values is a disclosure of every numerical value within that range, including the end points. It should also be appreciated that some components, features, and/or configurations may be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement.

It will be apparent to those skilled in the art that numerous modifications and variations of the described examples and embodiments are possible considering the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof.

It should be understood that modifications to the embodiments disclosed herein can be made to meet a particular set of design criteria. Therefore, while certain exemplary embodiments of the devices, systems, and methods of using and making the same disclosed herein have been discussed and illustrated, it is to be distinctly understood that the invention is not limited thereto but may be otherwise variously embodied and practiced within the scope of the following claims.

What is claimed is:

1. A method for fabricating a sintered sodium-ion material, the method comprising:
mixing a parent phase sodium-ion compound with a secondary transient phase to form a powder mixture;
applying pressure and heat above a melting point or boiling point of the secondary transient phase to drive dissolution at particle contacts and subsequent precipitation at newly formed grain boundaries; and
generating a sintered sodium-ion material with >90% relative density.

2. The method of claim 1, further comprising:
forming a solid electrolyte membrane using the sintered sodium-ion material;
forming a composite of β-alumina using the sintered sodium-ion material; or
forming a composite cathode using the sintered sodium-ion material.

3. The method of claim 1, wherein:
the parent phase sodium-ion compound is sodium beta alumina.

4. The method of claim 3, wherein:
the sodium beta alumina has an approximate composition of Na₁₊ₓ(MgₓAl₁₁₋ₓ)O₁₇(x=0.67).

5. The method of claim 1, wherein:
the parent phase sodium-ion compound is a solid phase.

6. The method of claim 1, wherein:
the mixture is 10% wt. % of the secondary transient phase.

7. The method of claim 1, wherein:
the secondary transient phase is a non-aqueous transient solvent.

8. The method of claim 7, wherein:
the non-aqueous transient solvent is a hydroxide-based transient solvent.

9. The method of claim 1, wherein:
the heat applied is within a range from 250° C. to 500° C.

10. The method of claim 1, further comprising:
a dwell time equal to or less than three hours.

11. The method of claim 1, wherein:
the pressure applied is within a range from 50 MPa to 400 MPa uniaxial pressure.

12. The method of claim 1, further comprising:
applying heat and pressure simultaneously.

13. The method of claim 1, further comprising:
annealing the sintered sodium-ion material.

14. The method of claim 13, wherein:
the annealing involves subjecting the sintered sodium-ion material to a temperature within a range from 900° C. or 1200° C.

15. The method of claim 1, further comprising:
improving electrical conductivity by reversing structural changes occurring during cold sintering by annealing the sintered sodium-ion material.

16. The method of claim 1, further comprising:
removing intercalated water or generated carbonates by annealing the sintered sodium-ion material.

17. The method of claim 1, further comprising:
forming a coherently bonded solid state battery by co-processing the sintered sodium-ion material into a solid electrolyte membrane and an electrode.

18. A solid state sodium-ion electrolyte membrane, comprising:
a sintered sodium-ion material with >90% relative density.

19. The solid state sodium-ion electrolyte membrane of claim 18, wherein:
the sintered sodium-ion material comprises sodium beta alumina.

20. The solid state sodium-ion electrolyte membrane of claim 19, wherein:
the sodium beta alumina has an approximate composition of Na₁₊ₓ(MgₓAl₁₁₋ₓ)O₁₇(x=0.67).
